(19) United States
(12) Patent Application Publication
(10) Pub. No.: US 2012/0183776 A1
(43) Pub. Date: Jul. 19, 2012

(54) CURABLE COMPOSITION, CURABLE FILM, CURABLE LAMINATE, METHOD FOR FORMING A PERMANENT PATTERN, AND PRINTED SUBSTRATE

(75) Inventors: Daisuke Arioka, Haibara-gun (JP); Hiroki Sasaki, Haibara-gun (JP); Toshiaki Hayashi, Haibara-gun (JP)

(73) Assignee: FUJIFILM CORPORATION, Minato-ku, Tokyo (JP)

(21) Appl. No.: 13/499,198

(22) PCT Filed: Sep. 16, 2010
(86) PCT No.: PCT/JP2010/066060

§ 371 Date: Mar. 29, 2012

(30) Foreign Application Priority Data
Sep. 30, 2009 (JP) 2009-228449
Mar. 31, 2010 (JP) 2010-083939

(51) Int. Cl. B32B 5/16; C08K 9/04

(52) U.S. Cl. 428/403; 523/209; 522/71

(57) ABSTRACT

A curable composition of the present invention includes resin-coated inorganic fine particles. The resin-coated inorganic fine particles may be formed by surface-modifying inorganic fine particles with a silane coupling agent containing an organic linking chain formed of a mercapto group, a hydroxyl group, an amino group, an isocyanato group, or a glycidyl group and then coating the surface-modified inorganic fine particles with a thermoplastic resin.

### TECHNICAL FIELD

The present invention relates to a curable composition suitable as solder resist materials, and a curable film, a curable laminate, a method for forming a permanent pattern, and a printed board using the curable composition.

### BACKGROUND ART

In the formation of permanent patterns such as solder resists, a curable liquid resist formed by coating a liquid resist directly on a substrate such as a copper-clad laminate, on which a permanent pattern is to be formed, and drying the coating to form a curing layer, and a curable film formed by coating a curable composition (a photosensitive composition) on a support and drying the coating to form a curing layer have hitherto been used. Methods for the formation of permanent patterns such as solder resists include, for example, a method that includes: stacking a curable film on a substrate such as a copper-clad laminate, on which a permanent pattern is to be formed, to form a laminate; exposing the curing layer (photosensitive layer) in the laminate to light; after the exposure, developing the curing layer to form a pattern; and then subjecting the pattern to curing treatment or the like to form a permanent pattern.

The solder resists have been used, for example, in the manufacture of printing wiring boards. In recent years, the solder resists have become used in new LSI packages such as BGAs and CSPs. Further, the solder resists are materials that, in a soldering step, are used as protective films for preventing solder from adhering to unnecessary portions or as a permanent mask.

Such solder resists are required to be excellent in various properties such as surface smoothness, heat resistance, toughness, developability, and insulating properties.

In particular, there is a recent demand for increased density of the printed board, leading to a tendency toward an improved wiring density and a further increase in number of output/input terminals. Accordingly, reducing the film thickness of the printed board and narrowing spacing between the printed board and components connected to the printed board are required. However, the reduction in film thickness of the printed board poses a problem of lowered surface smoothness of the printed board. When the surface smoothness of the printed board is unsatisfactory, the spacing between the printed board and the components cannot be kept evenly, posing a problem of poor connection. Accordingly, the spacing between the printed board and the components connected to the printed board cannot be narrowed.

For example, a curable composition including an alkali-soluble resin, a photopolymerization initiator, and a colorant, the alkali-soluble resin containing a specific alkali resin, is known as a curable composition that can improve the surface smoothness (see, for example, PTL 1).

This curable composition, however, is used for the suppression of wrinkles in a black matrix in a color filter and cannot satisfactorily solve the problem of poor connection or the like derived from the lowered surface smoothness. Further, various property requirements for the solder resist cannot be satisfied.

Accordingly, a curable composition that can simultaneously realize excellent surface smoothness, heat resistance, toughness, developability, and insulating properties has been demanded.

### CITATION LIST

### Patent Literature

PTL 1: Japanese Patent Application Laid-Open (JP-A) No. 2007-286478

### SUMMARY OF INVENTION

### Technical Problem

The present invention has been made with a view to solving the above-described various problems of the prior art and attaining the following object. An object of the present invention is to provide a curable composition possessing excellent surface smoothness, heat resistance, toughness, developability, and insulating properties, and a curable film, a curable laminate, a method for forming a permanent pattern, and a printed board using the curable composition.

### Solution to Problem

The above object can be attained by the following means.

<1> A curable composition including:

resin-coated inorganic fine particles.

<2> The curable composition according to <1>, further including a thermal crosslinking agent and a thermal curing accelerator.

<3> The curable composition according to <1> or <2>, further including a photopolymerization initiator and a polymerizable compound.

<4> The curable composition according to any one of <1> to <3>, further including a binder.

<5> The curable composition according to any one of <1> to <4>, wherein inorganic fine particles of the resin-coated inorganic fine particles are silica particles.

<6> The curable composition according to any one of <1> to <5>, wherein the resin-coated inorganic fine particles are formed by coating, with a thermoplastic resin, inorganic fine particles containing an organic linking chain formed of a mercapto group, a hydroxyl group, an amino group, an isocyanato group, or a glycidyl group.

<7> The curable composition according to <6>, wherein the thermoplastic resin is a resin obtained by polycondensation or addition polymerization.

<8> The curable composition according to <6> or <7>, wherein a difference in SP value between the thermoplastic resin and the binder is 5 MPa^{1/2} or less.

<9> The curable composition according to any one of <1> to <8>, wherein the curable composition is used as a curable composition for a printed board.

<10> A curable film including:

a support; and

a curing layer including the curable composition according to any one of <1> to <8>, the curing layer being provided on the support.

<11> A curable laminate including:

a substrate; and

a curing layer including the curable composition according to any one of <1> to <8>, the curing layer being provided on the substrate.

<12> A method for forming a permanent pattern, the method including:

exposing, to light, a curing layer formed of the curable composition according to any one of <1> to <8>.

<13> A printed board including:

a permanent pattern formed by the method for forming a permanent pattern according to <12>.

### Advantageous Effects of Invention

The present invention can solve the above various problems of the prior art, can attain the object of the present invention, and can provide a curable composition possessing excellent surface smoothness, heat resistance, roughness, developability, and insulating properties, and a curable film, a curable laminate, a method for forming a permanent pattern, and a printed board using the curable composition.

### DESCRIPTION OF EMBODIMENTS

### (Curable Composition)

The curable composition according to the present invention contains resin-coated fine particles and optionally a binder, a thermal crosslinking agent, a chain transfer agent, a photopolymerization initiator, a polymerizable compound, and other ingredients.

### <Resin-Coated Inorganic Fine Particles>

The resin-coated inorganic fine particles are not particularly limited as far as they are inorganic fine particles coated with a resin. Preferred are those formed by surface-modifying inorganic fine particles with a silane coupling agent and then coating the surface-modified inorganic fine particles with a resin.

In this case, the inorganic fine particles are reacted with the silane coupling agent to modify the surface of the inorganic fine particles. Subsequently, a functional group reactive with an organic compound contained in the silane coupling agent modified on the surface of the inorganic fine particles is reacted with a coating resin to form the resin-coated inorganic fine particles including the inorganic fine particles coated with the resin.

The average particle diameter of the resin-coated inorganic fine particles is not particularly limited and may be properly selected according to the contemplated purposes. For example, the average particle diameter is preferably 0.05 μm to 5.0 μm, more preferably 0.1 μm to 3.0 μm, particularly preferably 0.1 μm to 2.0 μm.

When the average particle diameter is less than 0.05 μm, the coatability of the curable composition is sometimes poor. On the other hand, when the average particle diameter exceeds 5.0 μm, the flatness of the pattern is sometimes lowered.

### —Inorganic Fine Particles—

The inorganic fine particles are not particularly limited and may be properly selected according to the contemplated purposes. Examples thereof include particles of metal oxides such as silica (SiO₂), alumina (Al₂O₃), titania (TiO₂), and zirconia (ZrO₂) and metal hydroxides. Among them, silica and alumina are preferred.

The average particle diameter of the inorganic fine particles is not particularly limited and may be properly selected according to the contemplated purposes. For example, the average particle diameter is preferably 0.01 μm to 5.0 μm, more preferably 0.05 μm to 3.0 μm, particularly preferably 0.1 μm to 2.0 μm.

When the average particle diameter is less than 0.01 μm, the coatability of the curable composition is sometimes poor. On the other hand, when the average particle diameter exceeds 5.0 μm, the flatness of the pattern is sometimes lowered.

The content of the curable composition in the resin-coated inorganic fine particles is not particularly limited and may be properly selected according to contemplated purposes. The content of the curable composition is preferably 1% by mass to 80% by mass, more preferably 5% by mass to 60% by mass, particularly preferably 10% by mass to 50% by mass.

When the content of the curable composition is less than 1% by mass, the heat resistance is sometimes poor. On the other hand, when the content of the curable composition exceeds 80% by mass, the pattern formation is sometimes poor.

### —Silane Coupling Agent—

The silane coupling agent is a silicon compound containing a functional group reactive with an inorganic compound and a functional group reactive with an organic compound. The silicon compound is not particularly limited and can be properly selected.

Examples of preferred functional groups in silane coupling agents include mercapto, hydroxy, amino, isocyanato, glycidyl, vinyl, methacryloyl, acryl, and styryl groups. Among them, functional groups containing organic linking groups formed of a mercapto group, a hydroxyl group, an amino group, an isocyanato group, a glycidyl group and other groups are preferred. For example, when the functional group is a vinyl or methacryloyl group, the heat resistance and toughness are sometimes poor.

Examples such silane coupling agents include vinyltrimethoxysilane, vinyltriethoxysilane, vinyltris(β-methoxyethoxy)silane, vinyltrichlorosilane, vinyltriacetoxysilane, N-(β-aminoethyl)-γ-aminopropyltrimethoxysilane, γ-aminopropyltrimethoxysilane, γ-aminopropyltriethoxysilane, γ-glycidoxypropyltrimethoxysilane, γ-glycidoxypropylmethyldimethoxysilane, β-(3,4-epoxycyclohexyl)ethyltrimethoxysilane, γ-methacryloxypropyltrimethoxysilane, methacryloxypropyltris(β-methoxyethoxy)silane, γ-mercaptopropyltrimethoxysilane, methyltrimethoxysilane, methyltriethoxysilane, hexamethyldisilazane, γ-anilinopropyltrimethoxysilane, and N-[β-(N-vinylbenzalamino)ethyl]-γ-aminopropyltrimethoxysilane hydrochyloride.

One type of silane coupling agents may be used, or alternatively, two or more types of silane coupling agents may be used in combination.

The surface treatment by the silane coupling may be carried out by any method without particular limitation, and examples of such methods include aqueous solution, organic solvent, and gas phase methods.

In the surface treatment, the addition amount of the silane coupling agent is not particularly limited, and the addition amount is preferably 0.1 parts by mass to 20 parts by mass, more preferably 0.2 parts by mass to 10 parts by mass, particularly preferably 0.2 parts by mass to 5 parts by mass, based on 100 parts by mass of the inorganic fine particles.

When the addition amount is less than 0.1 parts by mass, the surface of the particles cannot be sometimes satisfactorily coated. On the other hand, when the addition amount exceeds 20 parts by mass, aggregation among the particles sometimes occurs.

### —Resin—

The resin is not particularly limited and may be properly selected according to contemplated purposes. Examples thereof include thermoplastic resins.

The thermoplastic resin is not particularly limited and may be properly selected according to contemplated purposes. Preferred are resins obtained by any of polycondensation and addition polymerization.

The resins obtained by any of polycondensation and addition polymerization are not particularly limited and may be properly selected according to contemplated purposes. Examples thereof include polyethers, polyesters, polyurethanes, polyamides, polyimides, polyamic acids, polycarbonates, polyureas, and polyallylamines. Among them, polyethers, polyesters, polyurethanes, and polyamic acids are preferred.

The addition amount of the coating resin is not particularly limited but is preferably 0.1 part by mass to 100 parts by mass, more preferably 0.2 part by mass to 50 parts by mass, particularly preferably 0.2 part by mass to 20 parts by mass, based on 100 parts by mass of the inorganic fine particles.

When the addition amount is less than 0.1 parts by mass, the fine particles are not sometimes satisfactorily coated with the resin. On the other hand, when the addition amount exceeds 100 parts by mass, aggregation sometimes occurs among the particles.

The thermoplastic resin is not particularly limited and may be properly selected according to contemplated purposes. Preferably, the thermoplastic resin is highly compatible with the binder. Preferably, the SP value of the thermoplastic resin is different by a predetermined value from that of the binder.

The SP value of the thermoplastic resin is not particularly limited but is preferably different from that of the binder by 5 MPa^{1/2} or less, more preferably 4 MPa^{1/2} or less, particularly preferably 3 MPa^{1/2} or less.

When the SP value difference exceeds 5 MPa^{1/2}, the compatibility between the coating resin and the binder resin is deteriorated and, consequently, satisfactory heat resistance, toughness, and flatness cannot be sometimes developed.

The SP value is an index that indicates mutual solubility of substances, and a solubility parameter calculatable from a molecular structure is defined. For example, the Okitsu method is defined as the solubility parameter, and the SP value can be calculated by the parameter.

The curable composition containing the resin-coated inorganic fine particles formed by coating the inorganic fine particles with the resin can realize improved surface smoothness. The reason for this is considered to reside in that the resin coating allows the inorganic particles to be satisfactorily dispersed in the binder, and, consequently, the inorganic particles are less likely to be exposed on the surface.

### <Polymerizable Compound>

The polymerizable compound is not particularly limited and may be properly selected according to contemplated purposes. Examples of preferred polymerizable compounds include compounds containing one or more ethylenically unsaturated bonds.

Examples of such ethylenically unsaturated bonds include vinyl groups such as (meth)acryloyl, (meth)acrylamide, styryl, vinyl ester, and vinyl ether; and allyl groups such as allyl ether and allyl ester.

The compound containing one or more ethylenically unsaturated bonds is not particularly limited and may be properly selected according to contemplated purposes. For example, at least one compound selected from (meth)acryl-containing monomers is suitable.

The (meth)acryl-containing monomer is not particularly limited and may be properly selected according to contemplated purposes. Examples thereof include monofunctional acrylates and monofunctional methacrylates such as polyethylene glycol mono(meth)acrylate, polypropylene glycol mono(meth)acrylate, and phenoxyethyl (meth)acrylate; compounds obtained by subjecting polyfunctional alcohols such as polyethylene glycol di(meth)acrylate, polypropylene glycol di(meth)acrylate, trimethylolethane triacrylate, trimethylolpropane triacrylate, trimethylolpropane diacrylate, neopentyl glycol di(meth)acrylate, pentaerythritol tetra(meth)acrylate, pentaerythritol tri(meth)acrylate, dipentaerythritol hexa(meth)acrylate, dipentaerythritol penta(meth)acrylate, hexanediol di(meth)acrylate, trimethylolpropane tri(acryloyloxypropyl)ether, tri(acryloyloxyethyl)isocyanurate, tri(acryloyloxyethyl)cyanurate, glycerin tri(meth)acrylate, trimethylolpropane, glycerin or bisphenol to an addition reaction with ethylene oxide or propylene oxide and then (meth)acrylating the addition production; urethane acryaltes described, for example, in Japanese Patent Application Publication (JP-B) Nos. 48-41708 and 50-6034, and Japanese Patent Application Laid-Open (JP-A) No. 51-37193; polyester acrylates described, for example, in Japanese Patent Application Laid-Open (JP-A) No. 48-64183, Japanese Patent Application Publication (JP-B) Nos. 49-43191, and 52-30490; and polyfunctional acrylates or methacrylates such as epoxyacrylates that are reaction products between epoxy resins and (meth)acrylic acid. Among them, trimethylolpropane tri(meth)acrylate, pentaerythritol tetra(meth)acrylate, dipentaerythritol hexa(meth)acrylate, and dipentaerythritol penta(meth)acrylate are particularly preferred.

The solid content of the polymerizable compound in the solid matter of the curable composition is preferably 2% by mass to 50% by mass, more preferably 2% by mass to 40% by mass. When the solid content is 2% by mass or more, the developability (resolution) and the exposure sensitivity are good. On the other hand, when the solid content is 50% by mass or less, it is possible to prevent an enhancement of the tackiness of the curing layer to an excessively high value.

### <Photopolymerization Initiator>

The photopolymerization initiator is not particularly limited as long as it has a capability of initiating the polymerization of the polymerizable compound. The photopolymerization initiator may be properly selected according to contemplated purposes. For example, photopolymerization initiators that can allow polymerizable compounds to be cured upon exposure to light in a region from ultraviolet light to visible light are preferred. The hotopolymerization initiators may be activators that generate active radicals through some action on a photoexcited sensitizer, or alternatively may be initiators that initiate cation polymerization depending upon the type of the monomer.

Preferably, the photopolymerization initiator contains at least one ingredient that has a molecular extinction coefficient of at least about 50 in a wavelength range of about 300 nm to about 800 nm. The wavelength is more preferably 330 nm to 500 nm.

A neutral photopolymerization initiator is used as the photopolymerization initiator. If necessary, the photopolymerization initiator may contain other photopolymerization initiators.

The neutral photopolymerization initiator is not particularly limited and may be properly selected according to contemplated purposes. Compounds containing at least an aromatic group are preferred. (Bis)acylphosphine oxides or esters thereof, acetophenone compounds, benzophenone compounds, benzoin ether compounds, ketal derivative compounds, and thioxanthone compounds are more preferred. Two or more types of the neutral photopolymerization initiators may be used in conbination.

Examples of such photopolymerization initiators include (bis)acylphosphine oxides or esters thereof, acetophenone compounds, benzophenone compounds, benzoin ether compounds, ketal derivative compounds, thioxanthone compounds, oxime derivatives, organic peroxides, and thio compounds. Among them, oxime derivatives, (bis)acylphosphine oxides or esters thereof, acetophenone compounds, benzophenone compounds, benzoin ether compounds, ketal derivative compounds, and thioxanthone compounds are preferred, for example, from the viewpoints of the sensitivity of the curing layer, the storage stability, and the adhesion between the curing layer and the substrate for a printed circuit board.

Examples of such (bis)acylphosphine oxides include 2,6-dimethylbenzoyldiphenylphosphine oxide, 2,4,6-trimethylbenzoyldiphenylphosphine oxide, 2,4,6-trimethylbenzoylphenylphosphinic acid methyl ester, 2,6-dichlorobenzoylphenylphosphine oxide, 2,6-dimethyloxybenzoyldiphenylphosphine oxide, bis(2,6-dimethyloxybenzoyl)-2,4,4-trimethyl-pentylphosphine oxide, and bis(2,4,6-trimethylbenzoyl)-phenylphosphine oxide.

Examples of such acetophenone compounds include acetophenone, methoxyacetophenone, 1-phenyl-2-hydroxy-2-methylpropan-1-one, 1-hydroxycyclohexyl phenyl ketone, 4-diphenoxydichloroacetophenone, diethoxyacetophenone, and 1-(4-isopropylphenyl)-2-hydroxy-2-methylpropan-1-one.

Examples of such benzophenone compounds include benzophenone, 4-phenylbenzophenone, methyl benzoylbenzoate, 4-phenylbenzophenone, hydroxybenzophenone, 3,3′-dimethyl-4-methoxybenzophenone, and diphenoxybenzophenone.

Examples of such benzoin ether compounds include benzoin ethyl ether and benzoin propyl ether.

Examples of such ketal derivative compounds include benzyl dimethyl ketal.

Examples of such thioxanthone compounds include 2-chlorothioxanthone, 2,4-dimethylthioxanthone, 2,4-diethylthioxanthone, 2,4-diisopropylthioxanthone, and isopropylthioxanthone.

Examples of oxime derivatives suitable in the present invention include compounds represented by General formula (1).

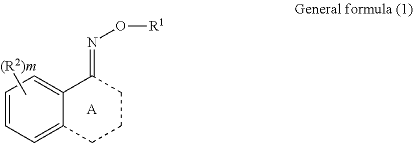

In General formula (1), R¹ represents any of a hydrogen atom and optionally substituted acyl, alkoxycarbonyl, allyloxycarbonyl, alkylsulfonyl, and allyl sulfonyl groups; R²s each independently represent a substituent; m is an integer of 0 to 4, provided that, when m is 2 or more, they may be mutually connected to form a ring; and A represents any of four-, five-, six-, and seven-membered rings with any of five- and six-membered rings being preferred.

For oxime compounds, matters described, for example, in Japanese Patent Application Laid-Open (JP-A) Nos. 2008-249857, 2008-242372, 2008⁻122546, and 2008-122545 are applicable.

### <Binders>

The binder is not particularly limited as long as the binder is a compound which has a curable group and into which an acid group for alkali developability imparting purposes has been introduced. The binder may be properly selected according to contemplated purposes. Examples thereof include acid group-introduced poly(meth)acrylic resins, polyesters, polyurethanes, polyamides, polyamic acids, polyethers, polyureas, and polycarbonates. Additional examples thereof include polymers obtained by reacting an epoxy resin containing two or more epoxy groups with a vinyl-containing organic acid and then further reacting the reaction product with a polybasic acid anhydride; modified copolymers obtained by adding a vinyl compound containing a glycidyl or alicyclic epoxy group to at least a part of acid groups in a carboxyl-containing resin; modified copolymers obtained by adding a vinyl compound containing an isocyanato or acid anhydride group to at least a part of hydroxyl groups in a hydroxyl-containing resin; modified copolymers obtained by adding a vinyl compound containing an isocyanato or acid anhydride group to at least a part of amino groups in an amino-containing resin; copolymers of vinyl-containing diols or diamines; and ring-opened polymers of a vinyl compound containing a glycidyl, oxetanyl, or alicyclic epoxy group.

Among them, polymers obtained by reacting an epoxy resin containing two or more epoxy groups with a vinyl-containing organic acid and then further reacting the reaction product with a polybasic acid anhydride and polyurethene resins including polyisocyanate and polyisocyanate are preferred.

Regarding the polyurethane resin, acid-modified vinyl-containing polyurethane resins having a structure derived from polyisocyanate and polyisocyanate are preferred from the viewpoints of alkali develop ability and toughness of cured films.

### <<Acid-Modified Vinyl-Containing Polyurethane Resin>>

The acid-modified vinyl-containing polyurethane resin is not particularly limited and may be properly selected according to contemplated purposes. Examples of such modified vinyl-containing polyurethane resins include (i) polyurethane resins having an ethylenically unsaturated bond on a side chain thereof and (ii) polyurethane resins obtained by reacting a carboxyl-containing polyurethane with a compound having an epoxy group and vinyl in a molecule thereof.

### —(i) Polyurethane Resin Having Vinyl on Side Chain Thereof—

The polyurethane resin having vinyl on side chain thereof is not particularly limited and may be properly selected according to contemplated purposes. Examples of such polyurethane resins having vinyl on side chain thereof include polyurethane resins having at least one of functional groups represented by General formulae (2) to (4).

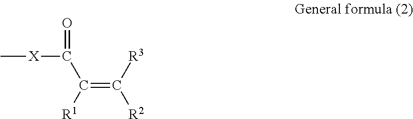

In General formula (2), R¹ to R³ each independently represent a hydrogen atom or a monovalent organic group. R¹ is not particularly limited and may be properly selected according to contemplated purposes. Examples thereof include a hydrogen atom and optionally substituted alkyl groups. Among them, a hydrogen atom and a methyl group are preferred from the viewpoint of high radical reactivity. R² and R³ are not particularly limited and may be properly selected according to contemplated purposes. For example, R² and R³ each independently may represent a hydrogen atom, a halogen atom or an amino, carboxyl, alkoxycarbonyl, sulfo, nitro, cyano, optionally substituted alkyl, optionally substituted aryl, optionally substituted alkoxy, optionally substituted aryloxy, optionally substituted alkylamino, optionally substituted arylamino, optionally substituted alkylsulfonyl, or optionally substituted arylsulfonyl group. Among them, a hydrogen atom and carboxyl, alkoxycarbonyl, optionally substituted alkyl, and optionally substituted aryl groups are preferred from the viewpoint of high radical reactivity.

In General formula (2), X represents an oxygen atom, a sulfur atom, or —N(R¹²)—. R¹² represents a hydrogen atom or a monovalent organic group. R¹² is not particularly limited and may be properly selected according to contemplated purposes. Examples thereof include optionally substituted alkyl groups. Among them, a hydrogen atom and methyl, ethyl, and isopropyl groups are preferred from the viewpoint of high radical reactivity.

The substituents that can be introduced are not particularly limited and may be properly selected according to contemplated purposes. Examples thereof include alkyl, alkenyl, alkynyl, aryl, alkoxy, aryloxy, halogen atom, amino, alkylamino, aryl amino, carboxyl, alkoxycarbonyl, sulfo, nitro, cyano, amide, alkylsulfonyl, and arylsulfonyl groups.

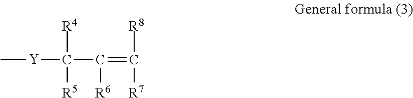

In General formula (3), R⁴ to R⁸ each independently represent a hydrogen atom or a monovalent organic group. R⁴ to R⁸ are not particularly limited and may be properly selected according to contemplated purposes. Examples thereof include a hydrogen atom, a halogen atom, and amino, dialkylamino, carboxyl, alkoxycarbonyl, sulfo, nitro, cyano, optionally substituted alkyl, optionally substituted aryl, optionally substituted alkoxy, optionally substituted aryloxy, optionally substituted alkylamino, optionally substituted arylamino, optionally substituted alkylsulfonyl, and optionally substituted arylsulfonyl. Among them, a hydrogen atom, carboxyl, alkoxycarbonyl, optionally substituted alkyl, and optionally substituted aryl groups are preferred from the viewpoint of high radical reactivity.

The substituents that can be introduced may be the same as those in General formula (2). Y represents an oxygen atom, a sulfur atom, or N(R¹²)—. R¹² is as defined in General formula (3), and preferred examples thereof are the same as those in General formula (3).

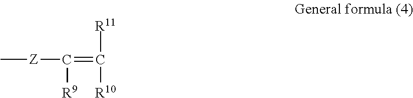

In General formula (4), R⁹ to R¹¹ each independently represent a hydrogen atom or a monovalent organic group. In General formula (4), R⁹ is not particularly limited and may be properly selected according to contemplated purposes. Examples thereof include a hydrogen atom or optionally substituted alkyl groups. Among them, a hydrogen atom and a methyl group are preferred from the viewpoint of high radical reactivity. In General formula (4), R¹⁰ and R¹¹ are not particularly limited and may be properly selected according to contemplated purposes. Examples thereof include a hydrogen atom, a halogen atom, and amino, dialkylamino, carboxyl, alkoxycarbonyl, sulfo, nitro, cyano, optionally substituted alkyl, optionally substituted aryl, optionally substituted alkoxy, optionally substituted aryl oxy, optionally substituted alkylamino, optionally substituted aryl amino, optionally substituted alkylsulfonyl, and optionally substituted arylsulfonyl. Among them, a hydrogen atom and carboxyl, alkoxycarbonyl, optionally substituted alkyl and optionally substituted aryl groups are preferred from the viewpoint of high radical reactivity.

Examples of substituents that can be introduced include those as defined in General formula (2). Z represents an oxygen atom, a sulfur atom, —N(R¹³)—, or an optionally substituted phenylene group. R¹³ is not particularly limited and may be properly selected according to contemplated purposes. Examples thereof include optionally substituted alkyl groups. Among them, methyl ethyl, and isopropyl groups are preferred from the viewpoint of high radical reactivity.

The urethane resin having an ethylenically unsaturated bond on a side chain thereof is a polyurethane resin having a basic skeleton including structural units represented by a reaction product between at least one diisocyanate compound represented by General formula (5) and at least one diol compound represented by General formula (6).

OCN—X⁰—NCO General formula (5)

HO—Y⁰—OH General formula (6)

In General formula (5) and (6), X⁰ and Y⁰ each independently represent a divalent organic residue.

When at least one of diisocyanate compounds represented by General formula (5) and diol compounds represented by General formula (6) has at least one of groups represented by General formulae (2) to (4), polyurethane resins having side chains into which groups represented by General formulae (2) to (4) have been introduced are produced as reaction products between the diisocyanate compounds and the diol compounds. According to this method, polyurethane resins having side chains into which groups represented by General formulae (2) to (4) have been introduced can be more easily produced than in a method, after the production of a polyurethane resin by a reaction, a desired side chain is substituted or introduced.

The diisocyanate compound represented by General formula (5) is not particularly limited and may be properly selected according to contemplated purposes. Examples thereof include products obtained by subjecting a triisocyanate compound to an addition reaction with one equivalent of a monofunctional alcohol or monofunctional amine compound having an unsaturated group.

The triisocyanate compound is not particularly limited and may be properly selected according to contemplated purposes. Examples thereof include compounds described in paragraphs [0034] and [0035] in Japanese Patent Application Laid-Open (JP-A) No. 2005-250438.

The monofunctional alcohol having an unsaturated group or monofunctional amine compound is not particularly limited and may be properly selected according to contemplated purposes. Examples thereof include compounds described in paragraphs [0037] to [0040] in Japanese Patent Application Laid-Open (JP-A) No. 2005-250438.

The unsaturated group may be introduced into a side chain in the polyurethane resin by any method without particular limitation, and the method may be properly selected according to contemplated purposes. A method using a diisocyanate compound having an unsaturated group on a side chain thereof is preferred as a starting material for the production of polyurethane resins. The diisocyanate compound is not particularly limited and may be properly selected according to contemplated purposes. Examples thereof include compounds that are diisocyanate compounds obtainable by subjecting a triisocyanate compound to an addition reaction with one equivalent of a monofunctional alcohol or monofunctional amine compound having an unsaturated group. Examples thereof include compounds having an unsaturated group on a side chain described in paragraphs [0042] to [0049] in Japanese Patent Application Laid-Open (JP-A) No. 2005-250438.

The polyurethane resin having an ethylenically unsaturated bond on a side chain thereof may also be copolymerized with a diisocyanate compound other than the diisocyanate compound containing an unsaturated group from the viewpoints of improving compatibility with other ingredients in the polymerizable composition and improving the storage stability.

The diisocyanate compound to be copolymerized is not particularly limited and may be properly selected according to contemplated purposes. Examples thereof include diisocyanate compounds represented by General formula (7).

OCN-L¹-NCO General formula (7)

In General formula (7), L¹ represents an optionally substituted divalent aliphatic or aromatic hydrocarbon group. If necessary, L¹ may have other functional group, for example, an ester, urethane, amide, or ureido group that is not reactive with the isocyanate group.

The diisocyanate compound represented by General formula (7) is not particularly limited and may be properly selected according to contemplated purposes. Examples thereof include aromatic diisocyanate compounds such as 2,4-tolylene diisocyanate, a dimer of 2,4-tolylene diisocyanate, 2,6-tolylenedilene diisocyanate, p-xylylene diisocyanate, m-xylylene diisocyanate, 4,4′-diphenylmethane diisocyanate, 1,5-naphthylene diisocyanate, and 3,3′-dimethylbiphenyl-4,4′-diisocyanate; aliphatic diisocyanate compounds such as hexamethylene diisocyanate, trimethylhexamethylene diisocyanate, lysine diisocyanate, and dimer acid diisocyanate; alicyclic diisocyanate compounds such as isophorone diisocyanate, 4,4′-methylenebis(cyclohexyl isocyanate), methylcyclohexane-2,4- (or 2,6-) diisocyanate, and 1,3-(isocyanate methyl)cyclohexane; and diisocyanate compounds that are a reaction product between a diol such as an addition product of one mole of 1,3-butylene glycol and 2 moles of tolylene diisocyanate and diisocyanate.

The diol compounds represented by General formula (6) are not particularly limited and may be properly selected according to contemplated purposes. Examples thereof include polyether diol compounds, polyester diol compounds, and polycarbonates diol compounds.

In order to introduce an unsaturated group into a side chain in the polyurethane resin, in addition to the above method, a method is preferably adopted in which a diol compound having an unsaturated group on a side chain thereof is used as the starting material for the production of the polyurethane resin: Examples such diol compounds containing an unsaturated group on a side chain thereof include trimethylolpropane monoaryl ether, which is commercially available, or compounds that can easily be produced by a reaction of a compound such as a halogenated diol compound, triol compound, or amino diol compound with a compound such as an unsaturated group-containing carboxylic acid, acid chloride, isocyanate, alcohol, amine, thiol, or a halogenated alkyl compound. The diol compound having an unsaturated group on a side chain thereof is not particularly limited and may be properly selected according to contemplated purposes. Examples thereof include compounds described in paragraphs [0057] to [0060] in Japanese Patent Application Laid-Open (JP-A) No. 2005-250438 and compounds represented by a General formula (G) described in paragraphs [0064] to [0066] in Japanese Patent Application Laid-Open (JP-A) No. 2005-250438. Among them, compounds represented by a General formula (G) described in paragraphs [0064] to [0066] in Japanese Patent Application Laid-Open (JP-A) No. 2005-250438 are preferred.

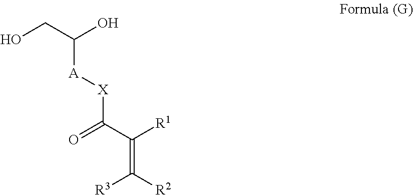

In General formula (G), R¹ to R³ each independently represent a hydrogen atom or a monovalent organic group; A represents a divalent organic residue; X represents an oxygen atom, a sulfur atom, or N(R¹²)—; and R¹² represents a hydrogen atom or a monovalent organic group.

R¹ to R³ and X in General formula (G) are as defined in General formula (2). Preferred embodiments in conjunction with R¹ to R³ and X in General formula (G) are the same as described in connection with General formula (2).

It is considered that, when polyurethane resins derived from diol compounds represented by General formula (G) are used, the layer strength can be improved by the effect of suppressing excessive molecular movement of the main chain of the polymer attributable to a secondary alcohol having a large steric hindrance.

The polyurethane resin having an ethylenically unsaturated bond on a side chain thereof may also be copolymerized with a diol compound other than the diol compound having an unsaturated group on a side chain thereof from the viewpoints of improving compatibility with other ingredients in the polymerizable composition and improving the storage stability.

Diol compounds other than the diol compound having an unsaturated group on a side chain thereof are not particularly limited and may be properly selected according to contemplated purposes. Examples thereof include polyether diol compounds, polyester diol compounds, and polycarbonate diol compounds.

The polyether diol compound is not particularly limited and may be properly selected according to contemplated purposes. Examples thereof include compounds described in paragraphs [0068] to [0076] in Japanese Patent Application Laid-Open (JP-A) No. 2005-250438.

The polyester diol compound is not particularly limited and may be properly selected according to contemplated purposes. Examples thereof include compounds described in paragraphs [0077] to [0079] and compounds described as Nos. 1 to 8 and Nos. 13 to 18 in paragraphs [0083] to [0085] in Japanese Patent Application Laid-Open (JP-A) No. 2005-250438.

The polycarbonate diol compound is not particularly limited and may be properly selected according to contemplated purposes. Examples thereof include compounds described in paragraphs [0080] and [0081] and compounds described as Nos. 9 to 12 in paragraph [0084] in Japanese Patent Application Laid-Open (JP-A) No. 2005-250438.

In the synthesis of the polyurethane resin having an ethylenically unsaturated bond on a side chain thereof, the diol compound may also be used in combination with a diol compound having a substituent nonreactive with the isocyanate group.

The diol compound having a substituent nonreactive with the isocyanate is not particularly limited and may be properly selected according to contemplated purposes. Examples thereof include compounds described in paragraphs [0087] and [0088] in Japanese Patent Application Laid-Open (JP-A) No. 2005-250438.

Further, in the synthesis of the polyurethane resin containing an ethylenically unsaturated bond on a side chain thereof, the diol compound may also be used in combination with a diol compound having a carboxyl group. Examples of diol compounds having a carboxyl group include compounds represented by formulae (1) to (3).

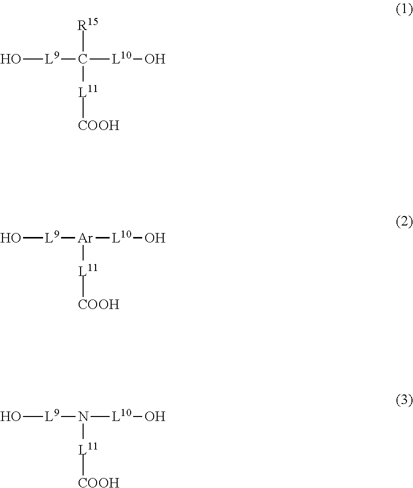

In formulae (1) to (3), R¹⁵ is not particularly limited and may be properly selected according to contemplated purposes, as long as it represents a hydrogen atom or an alkyl, aralkyl, aryl, alkoxy, or aryloxy group optionally substituted, for example, by a cyano group, a nitro group, a halogen atom such as —F, —Cl, —Br, or —I, —CONH₂, —COOR¹⁶, —OR¹⁶, —NHCONHR¹⁶, —NHCOOR¹⁶, —NHCOR¹⁶, or —OCONHR¹⁶ wherein R¹⁶ represents an alkyl group having 1 to 10 carbon atoms or an aralkyl group having 7 to 15 carbon atoms. Preferably, R¹⁵ represents a hydrogen atom, an alkyl group having 1 to 8 carbon atoms, or an aryl group having 6 to 15 carbon atoms. In formulae (1) to (3), L⁹, L¹⁰, and L¹¹, which may be the same or different, are not particularly limited and may be properly selected according to contemplated purposes, as long as they represent a single bond or a divalent aliphatic or aromatic hydrocarbon group optionally substituted, for example, by an alkyl, aralkyl, aryl, alkoxy, or halogeno group. Preferably, L⁹, L¹⁰, and L¹¹ represent an alkylene group having 1 to 20 carbon atoms or an arylene group having 6 to 15 carbon atoms. More preferably, L⁹, L¹⁰, and L¹¹ represent an alkylene group having 1 to 8 carbon atoms. If necessary, other functional group nonreactive with the isocyanate group, for example, a carbonyl, ester, urethane, amide, ureido, or ether group may be present in L⁹ to L¹¹. Two or three of R¹⁵, L⁷, L⁸, and L⁹ together may form a ring.

In formula (3), Ar is not particularly limited and may be properly selected according to contemplated purposes, as long as it represents an optionally substituted trivalent aromatic hydrocarbon group. Preferably, Ar represents an aromatic group having 6 to 15 carbon atoms.

The carboxyl-containing diol compound represented by formulae (1) to (3) is not particularly limited and may be properly selected according to contemplated purposes. Examples thereof include 3,5-dihydroxybenzoic acid, 2,2-bis(hydroxymethyl)propionic acid, 2,2-bis(2-hydroxyethyl)propionic acid, 2,2-bis(3-hydroxypropyl)propionic acid, bis(hydroxymethyl)acetic acid, bis(4-hydroxyphenyl)acetic acid, 2,2-bis(hydroxymethyl)butyric acid, 4,4-bis(4-hydroxyphenyl)pentanoic acid, tartaric acid, N,N-dihydroxyethylglycine, and N,N-bis(2-hydroxyethyl)-3-carboxy-propionamide.

The presence of the carboxyl group is preferred because properties such as hydrogen bond properties and alkali solubility can be imparted to the polyurethane resin. More specifically, the polyurethane resin having an ethylenically unsaturated bond group on a side chain thereof is preferably the resin further having a carboxyl group on a side chain thereof. More specifically, vinyl on the side chain is preferably 0.05 mmol/g to 1.80 mmol/g, more preferably 0.5 mmol/g to 1.80 mmol/g, particularly preferably 0.75 mmol/g to 1.60 mmol/g. Further, the presence of a carboxyl group on a side chain is preferred, and the acid value is preferably 20 mgKOH/g to 120 mgKOH/g, more preferably 30 mgKOH/g to 110 mgKOH/g, particularly preferably 35 mgKOH/g to 100 mgKOH/g.

In the synthesis of the polyurethane resin having an ethylenically unsaturated bond on a side chain thereof, the diol compound may be used in combination with a compound obtained by ring-opening a tetracarboxylic acid dianhydride with a diol compound.

The compound obtained by ring-opening a tetracarboxylic acid dianhydride with a diol compound is not particularly limited and may be properly selected according to contemplated purposes. Examples thereof include compounds described in paragraphs [0095] to [0101] in Japanese Patent Application Laid-Open (JP-A) No. 2005-250438.

The polyurethane resin having an ethylenically unsaturated bond on a side chain thereof is synthesized by heating the diisocyanate compound and diol compound in an aprotic solvent after the addition of a conventional active catalyst depending upon the reactivity. The molar ratio of the diisocyanate compound to the diol compound (Mₐ:M_{b}) used in the synthesis is not particularly limited and may be properly selected according to contemplated purposes. The ratio is preferably 1:1 to 1.2:1, and treatment with an alcohol, an amine or the like can allow a product having desired properties in terms of molecular weight and viscosity to be finally synthesized without residual isocyanate group.

The amount of the ethylenically unsaturated bond group introduced into the polyurethane resin having an ethylenically unsaturated bond on a side chain thereof is not particularly limited and may be properly selected according to contemplated purposes. The amount of the ethylenically unsaturated bond group introduced in terms of vinyl group equivalent is preferably 0.05 mmol/g to 1.8 mmol/g, more preferably 0.5 mmol/g to 1.8 mmol/g, particularly preferably 0.75 mmol/g to 1.6 mmol/g. Further, in the polyurethane resin having an ethylenically unsaturated bond on a side chain thereof, preferably, in addition to the ethylenically unsaturated bond group, a carboxyl group is introduced into the side chain. The acid value is preferably 20 mgKOH/g to 120 mgKOH/g, more preferably 30 mgKOH/g to 110 mgKOH/g, particularly preferably 35 mgKOH/g to 100 mgKOH/g.

The molecular weight of the polyurethane resin having an ethylenically unsaturated bond on a side chain thereof is not particularly limited and may be properly selected according to contemplated purposes. The molecular weight in terms of mass average molecular weight is preferably 5,000 to 50,000, more preferably 5,000 to 30,000. In particular, when the curable composition according to the present invention is used in a curable solder resist, the curable composition has an excellent capability of dispersing an inorganic filler therein, possesses excellent crack resistance and heat resistance, can provide excellent developability of non-image areas with an alkaline developing solution.

Polyurethane resins that further additionally have an unsaturated group at a polymer end or a main chain are also suitable as the polyurethane resin having an ethylenically unsaturated bond on a side chain thereof. The presence of an unsaturated group at a polymer end or a main chain can further improve crosslinking reactivity between the curable composition and the polyurethane resin having an ethylenically unsaturated bond on a side chain thereof or between the polyurethane resins having an ethylenically unsaturated bond on a side chain thereof and can increase the strength of a photocured product. Accordingly, when the polyurethane resin having an ethylenically unsaturated bond on a side chain thereof is used in planographic printing plates, plates having excellent plate wear can be provided. Here the unsaturated group particularly preferably has a carbon-carbon double bond from the viewpoint of easiness in the crosslinking reaction.

The unsaturated group may be introduced into the polymer end by the following method. Specifically, in the step of treating the residual isocyanate group at the polymer end with an alcohol or amine compound in the synthesis of the polyurethane resin having ethylenically unsaturated bond on a side chain thereof, an alcohol or amine compound having an unsaturated group may be used. Specific examples of such compounds include compounds exemplified above as unsaturated group-containing monofunctional alcohol or monofunctional amine compounds.

The introduction of the unsaturated group into the side chain of the polymer rather than the end of the polymer is preferred from the viewpoints of easy regulation of introduction amount to increase the amount of the unsaturated group introduced and an improved crosslinking reaction efficiency.

The ethylenically unsaturated bond group introduced is not particularly limited and may be properly selected according to contemplated purposes. Methacryloyl, acryloyl, and styryl groups are preferred from the viewpoint of the formation of the crosslinking cured film. Methacryloyl and acryloyl groups are more preferred. A methacryloyl group is particularly preferred from the viewpoint of simultaneously realizing both formation and raw storage stability of the crosslinking cured film.

The amount of the methacryloyl group introduced is not particularly limited and may be properly selected according to contemplated purposes. The amount of the methacryloyl group introduced in terms of vinyl equivalent is preferably 0.1 mmol/g to 3.0 mmol/g, more preferably 0.5 mmol/g to 2.7 mmol/g, particularly preferably 1.0 mmol/g to 2.4 mmol/g.

The vinyl equivalent can be determined, for example, by measuring a bromine value. The bromine value can be measured, for example, according to Japanese Industrial Standards (JIS) K 2605.

The unsaturated group may be introduced into the main chain by a method in which a diol compound having an unsaturated group in a main chain direction is used in the synthesis of the polyurethane resin. The diol compound having an unsaturated group in a main chain direction is not particularly limited and may be properly selected according to contemplated purposes. Examples thereof include cis-2-butene-1,4-diol, trans-2-butene-1,4-diol, and polybutadienediol.

The polyurethane resin having an ethylenically unsaturated bond on a side chain thereof can also be used in combination with an alkali-soluble polymer containing a polyurethane resin having a structure different from the specific polyurethane resin. For example, the polyurethane resin having an ethylenically unsaturated bond on a side chain thereof can be used in combination with a polyurethane resin containing an aromatic gorup on a main chain and/or a side chain thereof.

Specific examples of (i) the polyurethane resin having an ethylenically unsaturated bond on a side chain thereof include polymers of P-1 to P-31 described in paragraphs [0293] to [0310] in Japanese Patent Application Laid-Open (JP-A) No. 2005-250438. Among them, polymers of P-27 and P-28 described in paragraphs [0308] and [0309] are preferred.

—(ii) Polyurethane Resin Obtained by Reacting Carboxyl-Containing Polyurethane with Compound Having Epoxy and Vinyl Groups in its Molecule—

The polyurethane resin is a polyurethane resin obtained by reacting a carboxyl-containing polyurethane including a diisocyanate and a carboxylic acid group-containing diol as indispensable components with a compound having epoxy and vinyl groups in its molecule. According to contemplated purposes, a low-molecular diol having a mass average molecular weight of 300 or less or a low-molecular diol having a mass average molecular weight of 500 or more, which is a diol component, may be added as a comonomer ingredient.

The polyurethane resin can realize stable dispersibility of the inorganic filler and possesses excellent cracking resistance and impact resistance. Thus, heat resistance, moist heat resistance, adhesion, mechanical properties, and electric characteristics are improved.

The polyurethane resin may be obtained by providing a reaction product of diisocyanates of optionally substituted divalent aliphatic and aromatic hydrocarbons and a carboxylic acid-containing diol having a COOH group and two OH groups through any of a C atom and a N atom as indispensable components and reacting the reaction product with a compound having epoxy and vinyl groups in its molecule through a —COO— bond.

The polyurethane resin may also be obtained by providing a reaction product of a diisocyanate represented by General formula (1) and at least one compound selected from carboxylic acid group-containing diols represented by General formulae (II-1) to (II-3) as indispensable components and at least one compound selected from high-molecular diols represented by General formulae (III-1) to (III-5) and having a mass average molecular weight of 800 to 3,000 according to contemplated purposes and reacting the reaction product with a compound that has epoxy and vinyl groups in its molecule and is represented by any of General formulae (IV-1) to (Iv-16).

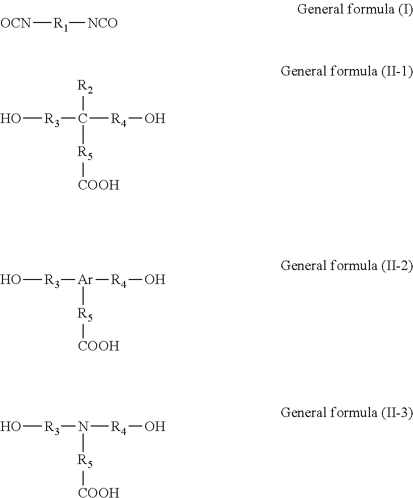

In General formula (1), R₁ represents a divalent aliphatic or aromatic hydrocarbon optionally substituted preferably, for example, by an alkyl, aralkyl, aryl, alkoxy, or halogeno group. If necessary, R₁ may have other functional group nonreactive with an isocyanate group, for example, any of ester, urethane, amide, and ureido groups. In General formula (1), R₂ represents a hydrogen atom or an alkyl, aralkyl, aryl, alkoxy, or aryloxy group optionally substituted, for example, by a cyano group, a nitro group, a halogen atom (—F, —Cl, —Br, or —I), —CONH₂, —COORS, —OR₆, —NHCONHR₆, —NHCOOR₆, —NHCOR₆, —OCONHR₆, or —CONHR₆ wherein R₆ represents any of an alkyl group having 1 to 10 carbon atoms or an aralkyl group having 7 to 15 carbon atoms. Among them, a hydrogen atom, alkyl groups having 1 to 3 carbon atoms, and aryl groups having 6 to 15 carbon atoms are preferred. In General formulae (II-1) and (II-2), R₃, R₄, and R₅, which may be the same or different, represent a single bond or a divalent aliphatic or aromatic hydrocarbon optionally substituted, preferably, for example, by an alkyl, aralkyl, aryl, alkoxy, or halogeno group. Among them, alkylene groups having 1 to 20 carbon atoms and arylene groups having 6 to 15 carbon atoms are preferred. More preferred are alkylene groups having 1 to 8 carbon atoms. If necessary, R₃, R₄, and R₅ may contain other functional group nonreactive with an isocyanate group, for example, any of carbonyl, ester, urethane, amide, ureido, and ether groups. Two or three of R₉, R₃, R₄, and R₅ together may form a ring. Ar represents an optionally substituted trivalent aromatic hydrocarbon, and aromatic groups having 6 to 15 carbon atoms are preferred.

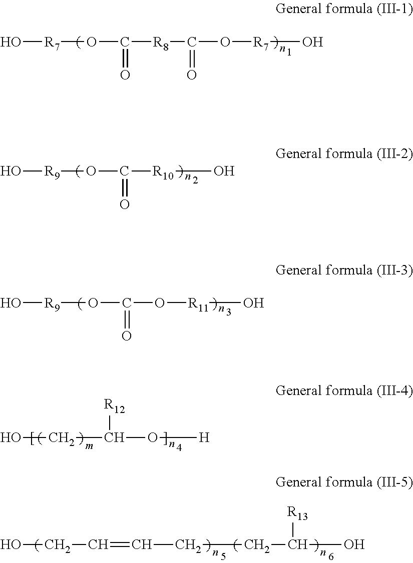

In formulae (III-1) to (III-3), R₇, R₈, R₉, R₁₀, and R₁₁, which may be the same or different, represent a divalent aliphatic or aromatic hydrocarbon. R₇, R₉, R₁₀, and R₁₁ each preferably represent an alkylene group having 2 to 20 carbon atoms or an arylene group having 6 to 15 carbon atoms, more preferably an alkylene group having 2 to 10 carbon atoms or an arylene group having 6 to 10 carbon atoms. R₈ represents an alkylene group having 1 to 20 carbon atoms or an arylene group having 6 to 15 carbon atoms, more preferably an alkylene group having 1 to 10 carbon atoms or an arylene group having 6 to 10 carbon atoms. R₇, R₈, R₉, R₁₀, and R₁₁ may contain a functional group nonreactive with an isocyante group, for example, an ether, carbonyl, ester, cyano, olefin, urethane, amide, or ureido group, or a halogen atom. In General formula (III-4), R₁₂ represents a hydrogen atom, an alkyl, aryl, aralkyl, or cyano group, or a halogen atom. R₁₂ preferably represents a hydrogen atom, an alkyl group having 1 to 10 carbon atoms, an aryl group having 6 to 15 carbon atoms, an aralkyl or cyano group having 7 to 15 carbon atoms, or a halogen atom, more preferably a hydrogen atom, an alkyl group having 1 to 6 carbon atoms, or an aryl group having 6 to 10 carbon atoms. R₁₂ may contain a functional group nonreactive with an isocyanate group, for example, an alkoxy, carbonyl, olefin, or ester group or a halogen atom.

In General formula (III-5), R₁₃ represents an aryl or cyano group, preferably an aryl or cyano group having 6 to 10 carbon atoms. In General formula (III-4), m is an integer of 2 to 4. In General formulae (III-1) to (III-5), n₁, n₂, n₃, n₄, and n₅ each are an integer of 2 or more, preferably an integer of 2 to 100. In General formula (III-5), n₆ is 0 or an integer of 2 or more, preferably 0 or an integer of 2 to 100.

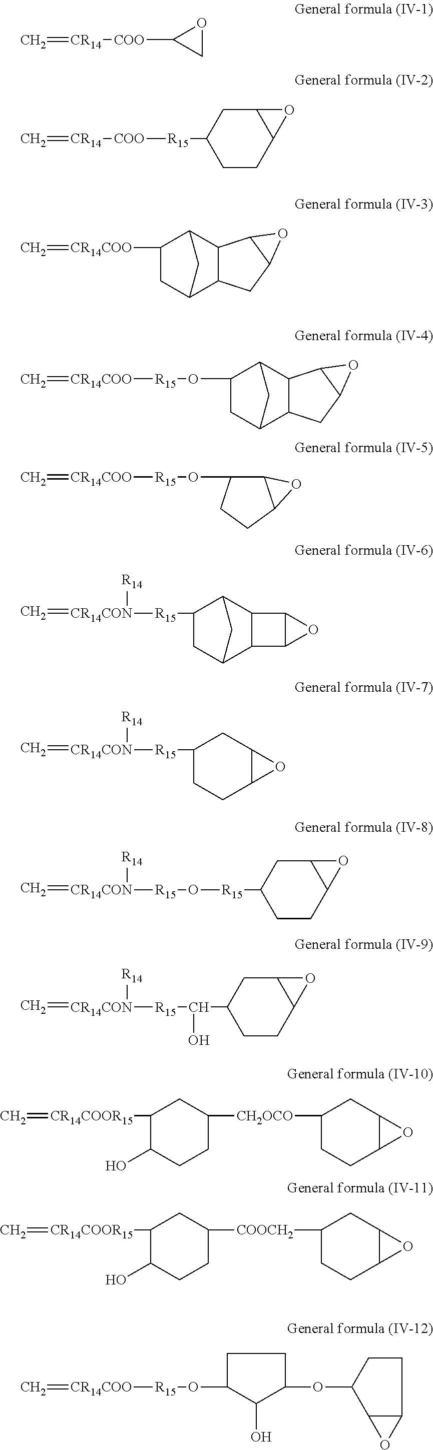

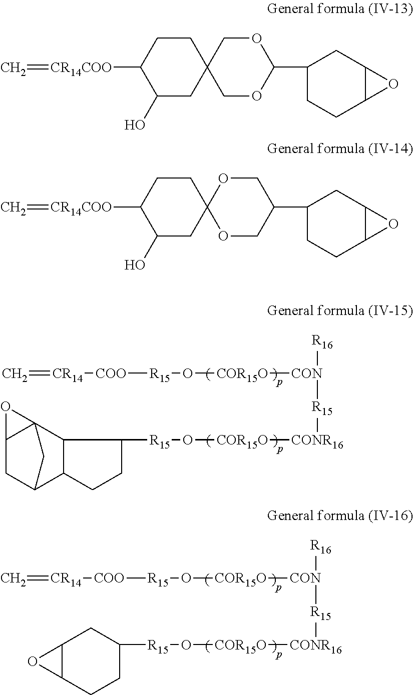

In General formulae (IV-1) to (IV-16), R₁₄ represents a hydrogen atom or a methyl group R₁₅ represents an alkylene group having 1 to 10 carbon atoms; R₁₆ represents a hydrocarbon group having 1 to 10 carbon atoms; and p is 0 or an integer of 1 to 10.

The polyurethane resin may further be copolymerized with a carboxylic acid group-free low-molecular weight diol as a fifth ingredient. Diols represented by General formulae (III-1) to (III-5) and having a mass average molecular weight of 500 or less may be mentioned as the low-molecular weight diol. The carboxylic acid group-free low-molecular weight diol may be added in such an amount range that does not lower alkali solubility and, at the same time, can satisfactorily maintain the modulus of elasticity of the cured film.

Particularly suitable polyurethane resins are alkali-soluble photocrosslinkable polyurethane resins that have an acid value of 20 mgKOH/g to 120 mgKOH/g and are obtained by providing a reaction product between a diisocyanate represented by General formula (I) and at least one diol selected from carboxylic acid group-containing diols represented by General formulae (II-1) to (II-3) as indispensable ingredients and at least one diol selected from high-molecular weight diols represented by General formulae (III-1) to (III-5) and having a mass average molecular weight in the range of 800 to 3,000 and a diol selected from carboxylic acid group-free low-molecular weight diols represented by General formulae (III-1) to (III-5) and having a mass average molecular weight of 500 or less according to contemplated purposes and further reacting the reaction product with a compound selected from compounds represented by General formulae (Iv-1) to (Iv-16) and having one epoxy and at least one (meth)acryl groups in a molecule thereof.

One type of these high-molecular weight compounds may be used, or alternatively two or more types of these high-molecular weight compounds may be used in combination. The content of the acid-modified vinyl-containing polyurethane resin in the total solid in the curable composition and the like is preferably 2% by mass to 30% by mass, more preferably 5% by mass to 25% by mass. When the content of the acid-modified vinyl-containing polyurethane resin is less than 2% by mass, a satisfactorily low modulus of elasticity cannot be sometimes obtained in the cured film at elevated temperatures. On the other hand, when the content of the acid-modified vinyl-containing polyurethane resin exceeds 30% by mass, lowered develop ability and lowered toughness of the cured film sometimes occur.

### —Process for Synthesizing Polyurethane Resin Obtained by Reacting Carboxyl-Containing Polyurethane and Compound Having Epoxy and Vinyl Groups in a Molecule Thereof—

The polyurethane resin may be synthesized by placing the diisocyanate compound and the diol compound(s) in an aprotic solvent, adding a conventional active catalyst depending upon the reactivity of the compounds, and heating the mixture. The molar ratio of the diisocyanate to the diol compound is preferably 0.8:1 to 1.2:1. When the isocyanate group stays at the end of the polymer, the treatment of the product with an alcohol or amine compound can allow the polyurethane resin to be finally synthesized without the residual presence of the isocyanate group.

### —Diisocyante—

The diisocyanate compound represented by General formula (1) is not particularly limited and may be properly selected according to contemplated purposes. Examples thereof include compounds described in paragraph [0021] in Japanese Patent Application Laid-Open (JP-A) No. 2007-2030.

### —High-Molecular Weight Diol—

The high-molecular weight diol compounds represented by General formulae (III-1) to (III-5) are not particularly limited and may be properly selected according to contemplated purposes. Examples thereof include compounds described in paragraphs [0022] to [0046] in Japanese Patent Application Laid-Open (JP-A) No. 2007-2030.

### —Carboxylic Acid Group-Containing Diol—

The carboxyl-containing diol compounds represented by General formulae (II-1) to (II-3) are not particularly limited and may be properly selected according to contemplated purposes. Examples thereof include compounds described in paragraph [0047] in Japanese Patent Application Laid-Open (JP-A) No. 2007-2030.

### —Carboxylic Acid Group-Free Low-Molecular Weight Diol—

The carboxylic acid group-free low-molecular weight diols are not particularly limited and may be properly selected according to contemplated purposes. Examples thereof include compounds described in paragraph [0048] in Japanese Patent Application Laid-Open (JP-A) No. 2007-2030.

The amount of comonomer of the carboxylic acid group-free diol in the low-molecular weight diol is preferably 95% by mole or less, more preferably 80% by mole or less, particularly preferably 50% by mole.

The amount of the comonomer exceeds 95% by mole, a urethane resin having good developability cannot be sometimes obtained.

Specific examples of polyurethane resins obtained by reacting (ii) the carboxyl-containing polyurethane with a compound having epoxy and vinyl groups in a molecule thereof include polymers obtained by replacing glycidyl acrylate as the epoxy- and vinyl-containing compound in polymers of U1 to U4 and U6 to U11 described in paragraphs [0314] and [0315] in Japanese Patent Application Laid-Open (JP-A) No. 2007-2030 with glycidyl methacrylate, 3,4-epoxycyclohexyl methylacrylate (tradename: CYCLOMER A400 (manufactured by Daicel Chemical Industries, Ltd.)) and 3,4-epoxycyclohexylmethyl methacrylate (tradename:CYCLOMER M400 (manufactured by Daicel Chemical Industries, Ltd.)).

The content of the acid-modified vinyl-containing polyurethane resin in the curable composition is not particularly limited and may be properly selected according to contemplated purposes. The content of the acid-modified vinyl-containing polyurethane resin is preferably 5% by mass to 80% by mass, more preferably 20% by mass to 75% by mass, particularly preferably 30% by mass to 70% by mass.

When the content of the acid-modified vinyl-containing polyurethane resin is less than 5% by mass, good crack resistance cannot be maintained. On the other hand, when the content of the acid-modified vinyl-containing polyurethane resin exceeds 80% by mass, the heat resistance can be spoiled. When the content of the acid-modified vinyl-containing polyurethane resin is in the particularly preferred range, good crack resistance and heat resistance are advantageously simultaneously realized.

The mass average molecular weight of the acid-modified vinyl-containing polyurethane resin is not particularly limited and may be properly selected according to contemplated purposes. The mass average molecular weight is preferably 5,000 to 60,000, more preferably 5,000 to 50,000, particularly preferably 5,000 to 30,000.

When the mass average molecular weight is less than 5,000, a satisfactory modulus of elasticity cannot be sometimes obtained in the cured film at elevated temperatures. On the other hand, when the mass average molecular weight exceeds 60,000, the coatability and developability are sometimes deteriorated.

The mass average molecular weight may be measured with a high-performance gel permeation chromatography (GPC) (HLC-802A, manufactured by TOSOH Co., Ltd.). A 0.5% by mass THF solution is used as a sample solution. One column of TSKgel HZM-M is provided. The sample (200 μL) is injected and eluted with the THF solution, followed by measurement at 25° C. with a refractive index detector or a UV detector (detection wavelength 254 nm). The mass average molecular weight was determined with a molecular weight distribution curve that had been calibrated using standard polystyrene.

The acid value of the acid-modified vinyl-containing polyurethane resin is not particularly limited and may be properly selected according to contemplated purposes. The acid value is preferably 20 mgKOH/g to 120 mgKOH/g, more preferably 30 mgKOH/g to 110 mgKOH/g, particularly preferably 35 mgKOH/g to 100 mgKOH/g.

When the acid value is less than 20 mgKOH/g, the developability is sometimes unsatisfactory. On the other hand, when the acid value exceeds 120 mgKOH/g, the development speed is so high that the regulation of the development becomes sometimes difficult.

The acid value may be measured, for example, according to JIS K 0070. When the sample does not melt, for example, dioxane or tetrahydrofuran is used as a solvent.

The vinyl group equivalent of the acid-modified vinyl-containing polyurethane resin is not particularly limited and may be properly selected according to contemplated purposes. The vinyl group equivalent is preferably 0.1 mmol/g to 3.0 mmol/g, more preferably 0.5 mmol/g to 2.7 mmol/g, particularly preferably 1.0 mmol/g to 2.4 mmol/g.

When the vinyl group equivalent is less than 0.1 mmol/g, the heat resistance of the cured film is sometimes poor. On the other hand, when the vinyl group equivalent exceeds 3.0 mmol/g, the crack resistance is sometimes deteriorated.

The vinyl group equivalent may be determined, for example, by measuring a bromine value. The bromine value may be measured, for example, according to JIS K 2605.

Preferably, in addition to the polyurethane resin, if necessary, other resins may be further added in an amount of 50% by mass or less based on the polyurethane resin to the curable composition of the present invention. Examples such resins include polyamide resins, epoxy resins, polyacetal resins, acrylic resins, methacrylic resins, polystyrene resins, and novolak phenol resins.

The solid content of the binder in the solid matter of curable composition is preferably 5% by mass to 80% by mass, more preferably 30% by mass to 70% by mass.

When the solid content is 5% by mass or more, the developability and exposure sensitivity are good. On the other hand, when the solid content is 80% by mass or less, it is possible to prevent the tackiness of the cured layer from becoming excessively high.

The solid content of the binder in the solid matter of curable composition is preferably 5% by mass to 80% by mass, more preferably 30% by mass to 70% by mass.

When the solid content is 5% by mass or more, the developability and exposure sensitivity are good. On the other hand, when the solid content is 80% by mass or less, it is possible to prevent the tackiness of the cured layer from becoming excessively high.

### <Thermal Crosslinking Agent>

The thermal crosslinking agent is not particularly limited and may be properly selected according to contemplated purposes. In order to improve the film strength after curing of the curing layer formed using the curable film, for example, compounds containing epoxy compounds, for example, epoxy compounds having at least two oxirane groups in one molecule, and oxetane compounds having at least two oxetanyl groups in one molecule can be used in such an amount that the developability is not adversely affected. Examples thereof include epoxy compounds having an oxirane group as described in Japanese Patent Application Laid-Open (JP-A) No. 2007-47729, epoxy compounds having an alkyl group at the β position, oxetane compounds having an oxetanyl group, polyisocyanate compounds, and compounds obtained by reacting an isocyanate group in a polyisocyanate and other derivatives with a blocking agent.

Melamine derivatives may be used as the thermal crosslinking agent. Examples of such melamine derivatives include methylol melamines and alkylated methylol melamines (compounds obtained by etherificating a methylol group with methyl, ethyl, butyl or the like). One of these melamine derivatives may be used, or alternatively, two or more types of these melamine derivatives may be used in combination. Among them, alkylated methylol melamines are preferred from the viewpoint of effectively improving the surface hardness of the cured layer or the film strength per se of the cured film, and hexamethylated methylol melamines are particularly preferred.

The solid content of the thermal crosslinking agent in the solid matter of the curable composition is preferably 1% by mass to 50% by mass, more preferably 3% by mass to 30% by mass. When the solid content is 1% by mass or more, the film strength of the cured film is improved. On the other hand, when the solid content is 50% by mass or less, the developability (resolution) and exposure sensitivity are good.

Examples of such epoxy compounds include epoxy compounds having at least two oxirane groups in one molecule and epoxy compounds containing at least two epoxy groups having an alkyl group at the β position in one molecule.

Examples of such epoxy compounds having at least two oxirane groups in one molecule include, but are not limited to, bixylenol or biphenol epoxy resins (for example, “YX4000, manufactured by Japan Epoxy Resin Co., Ltd.”) or their mixtures, heterocyclic epoxy resins having an isocyanurate skeleton or the like (for example, “TEPIC; manufactured by Nissan Chemical Industries Ltd.,” and “Araldite PT810; manufactured by Ciba Specialty Chemicals, K.K.”), bisphenol A epoxy resins, novolak epoxy resins, bisphenol F epoxy resins, hydrogenated bisphenol A epoxy resins, bisphenol S epoxy resins, phenol novolak epoxy resins, cresol novolak epoxy resins, halogenated epoxy resins (for example, low brominated epoxy resins, high halogenated epoxy resins, brominated phenol novolak epoxy resins), aryl-containing bisphenol A epoxy resins, trisphenolmethane epoxy resins, diphenyl dimethanol epoxy resins, phenol-biphenylene epoxy resins, dicyclopentadiene epoxy resins (for example, “HP-7200 and HP-7200H; manufactured by Dainippon Ink and Chemicals, Inc.”), glycidylamine epoxy resins (for example, diaminodiphenylmethane epoxy resins, diglycidylaniline, and triglycidyl aminophenol), glycidyl ester epoxy resins (for example, phthalic acid diglycidyl ester, adipic acid diglycidyl ester, hexahydrophthalic acid diglycidyl ester, and dimer acid diglycidyl ester), hydantoin epoxy resins, alicyclic epoxy resins (3,4-epoxycyclohexylmethyl-3′,4′-epoxycyclohexane carboxylate, bis(3,4-epoxycyclohexylmethyl)adipate, dicyclopentadienediepoxide, (for example, “GT-300, GT-400, and ZEHPE3150; manufactured by Daicel Chemical Industries, Ltd.”), imide alicyclic epoxy resins, trihydroxyphenylmethane epoxy resins, bisphenol A novolak epoxy resins, tetraphenylolethane epoxy resins, glycidyl phthalate resins, tetraglycidyl xylenoylethane resins, naphthalene group-containing epoxy resins (naphtholaralkyl epoxy resins, naphthol novolak epoxy resins, tetrafunctional naphthalene epoxy resins, commercially available products, for example, “ESN-190 and ESN-360; manufactured by Nippon Steel Chemical Co., Ltd.” and “HP-4032, EXA-4750, EXA-4700; manufactured by Dainippon Ink and Chemicals, Inc.,” reaction products between epichlorohydrin and polyphenol compounds obtained by subjecting phenol compounds to an addition reaction with diolefin compounds such as divinylbenzene or dicyclopentadiene, compounds obtained by epoxidizing an ring-opening polymerization product of 4-vinylcyclohexene-1-oxide with peracetic acid or the like, epoxy resins having a linear phosphorus-containing structure, epoxy resins having a cyclic phosphorus-containing structure, a-methylstilbene liquid crystal epoxy resins, dibenzoyloxybenzene liquid crystal epoxy resins, azophenyl liquid crystal epoxy resins, azomethine phenyl liquid crystal epoxy resins, binaphthyl liquid crystal epoxy resins, azine epoxy resins, glycidyl methacrylate copolymer epoxy resins (for example, “CP-50S and CP-50M; manufactured by Nippon Oils & Fats Co., Ltd.”), cyclohexyl maleimide/glycidyl methacrylate copolymer epoxy resins, and bis(glycidyl oxyphenyl)fluorene epoxy resins, and bis(glycidyl oxyphenyl)adamantane epoxy resins. One type of these epoxy resins may be used, or alternatively, two or more types of these epoxy resins may be used in combination.

Further, in addition to the epoxy compounds having at least two oxirane groups in one molecule, epoxy compounds containing at least two epoxy groups having an alkyl group at the β position in one molecule may be used. Compounds containing an epoxy group substituted at the β position by an alkyl group (more specifically, β-alkyl-substituted glycidyl group) are particularly preferred.

The epoxy compounds containing at least an epoxy group having an alkyl group at the β position may be epoxy compounds in which all of two or more epoxy groups contained in one molecule are a β-alkyl-substituted glycicyl group or epoxy compounds in which at least one epoxy group is a β-alkyl-substituted glycidyl group.

Examples of such oxetane compounds include oxetane compounds having at least two oxetanyl groups in one molecule.

Specific examples thereof include polyfunctional oxetanes such as bis[(3-methyl-3-oxetanylmethoxy)methyl]ether, bis[(3-ethyl-3-oxetanylmethoxy)methyl]ether, 1,4-bis[(3-methyl-3-oxetanylmethoxy)methyl]benzene, 1,4-bis[(3-ethyl-3-oxetanylmethoxy)methyl]benzene, (3-methyl-3-oxetanyl)methyl acrylate, (3-ethyl-3-oxetanyl)methyl acrylate, and (3-methyl-3-oxetanyl)methyl methacrylate, (3-ethyl-3-oxetanyl)methyl methacrylate or their oligomers or copolymers. Other examples thereof include ether compounds between oxetane group-containing compounds and hydroxyl-containing resins such as novolak resins, poly(p-hydroxystyrene), cardo bisphenols, calixarenes, calixresorcinarenes, and silsesquioxane. Additional examples thereof include copolymers between oxetane ring-containing unsaturated monomers and alkyl (meth)acrylates.

Polyisocyanate compounds described in Japanese Patent Application Laid-Open (JP-A) No. 05-9407 may be used as the polyisocyanate compound. The polyisocyanate compounds may be derived from aliphatic, cycloaliphatic or aromatic group-substituted aliphatic compounds containing at least two isocyanate groups. Specific examples thereof include bifunctional isocyanates (for example, a mixture of 1,3-phenylene diisocyanate with 1,4-phenylene diisocyanate, 2,4- and 2,6-toluene diisocyanates, 1,3- and 1,4-xylylene diisocyanates, bis(4-isocyanate-phenyl)methane, bis(4-isocyanate-cyclohexyl)methane, isophorone diisocyanate, hexamethylene diisocyanate, and trimethylhexamethylene diisocyanate), polyfunctional alcohols between the bifunctional isocyanate and trimethylolpropane, pentaerythritol or glycerine; and adducts between the alkylene oxide adducts of the polyfunctional alcohols and the bifunctional isocyanates; and cyclic trimers such as hexamethylene diisocyanate, hexamethylene-1,6-diisocyanate, and their derivatives.

Isocyanate blocking agents in compound obtained by reacting the polyisocyanate compound with a blocking agent, that is, compounds obtained by reacting an isocyanate group in a polyisocyanate and its derivative with a blocking gent include alcohols (for example, isopropanol and tert-butanol), lactams (for example, c-caprolactam), phenols (for example, phenol, cresol, p-tert-butyl phenol, p-sec-butyl phenol, p-sec-amyl phenol, p-octyl phenol, and p-nonyl phenol), heterocyclic hydroxyl compounds (for example, 3-hydroxypyridine, and 8-hydroxyquinoline), and active methylene compounds (for example, dialkyl malonate, methyl ethyl ketoxime, acetyl acetone, alkyl acetoacetate oxime, acetoxime, and cyclohexanone oxime). Examples of additional compounds usable herein include compounds having any of at least one polymerizable double bond and at least one block isocyanate group in a molecule thereof as described in Japanese Patent Application Laid-Open (JP-A) No. 06-295060.

Examples of melamine derivatives include methylol melamine and alkylated methylol melamines (compound obtained by etherificating a methylol group with methyl, ethyl, or butyl group). One type of these melamine derivatives may be used, or alternatively, two or more types of melamine derivatives may be used in combination. From the viewpoints of realizing good storage stability and effectively improving the surface hardness of the cured layer or the film strength per se of the cured film, among them, alkylated methylol melamines are preferred, and hexamethylated methylol melamine is particularly preferred.

### <Other Ingredients>

Other ingredients are not particularly limited and may be properly selected according to contemplated purposes. Examples thereof include thermal curing accelerators, thermal polymerization inhibitors, plasticizers, and colorants (coloring pigments or dyes). Further, the ingredients may be used in combination with promoters for adhesion to the surface of base materials and other auxiliaries (for example, electroconductive particles, fillers, antifoaming agents, flame retardants, levelling agents, peeling promoters, antioxidants, perfumes, surface tension regulating agents, and chain transfer agents).

Properties such as stability, photographic properties, and film properties are regulated as contemplated cured film by properly incorporating these ingredients.

The thermal polymerization inhibitor is described in detail, for example, in paragraphs [0101] and [0102] in Japanese Patent Application Laid-Open (JP-A) No. 2008-250074.

The thermal curing accelerator is described in detail, for example, in paragraph [0093] in Japanese Patent Application Laid-Open (JP-A) No. 2008-250074.

The plasticizer is described in detail, for example, in paragraphs [0103] and [0104] in Japanese Patent Application Laid-Open (JP-A) No. 2008-250074.

The colorant is described in detail, for example, in paragraphs [0105] and [0106] in Japanese Patent Application Laid-Open (JP-A) No. 2008-250074.

The adhesion promoter is described in detail, for example, in paragraphs [0107] to [0109] in Japanese Patent Application Laid-Open (JP-A) No. 2008-250074.

The content of the thermal curing accelerator is preferably 0.1% to 100%, more preferably 0.5% to 50%, particularly preferably 1% to 40%, based on the mass of the epoxy compound used.

When the content is less than 0.1%, the curable film is not satisfactorily heat-cured, sometimes resulting in deteriorated heat resistance of the cured film.

### (Curable Film)

The curable film according to the present invention includes at least a support and a curing layer that is provided on the support and is formed of the curable composition according to the present invention. The curable film may further include additional other layers according to need.

### —Support—

The support is not particularly limited and may be properly selected according to contemplated purposes. Preferably, the support can allow the cured layer to be separated therefrom and is highly permeable to light. More preferably, the support further has good surface smoothness.

The support is preferably formed of a synthetic resin and is transparent. Examples thereof include various plastic films of polyethylene terephthalate, polyethylene naphthalate, polypropylene, polyethylene, cellulose triacetate, cellulose diacetate, poly(meth)acrylic acid alkyl ester, poly(meth)acrylic acid ester copolymers, polyvinyl chloride, polyvinyl alcohol, polycarbonates, polystyrene, cellophane, polyvinylidene chloride copolymers, polyamides, polyimides, vinyl chloride/vinyl acetate copolymers, polytetrafluoroethylene, polytrifluoroethylene, cellulosic films, and nylon films. Among them polyethylene terephthalate films are particularly preferred. One type of these films may be used, or alternatively, two or more types of these films may be used in combination.

The thickness of the support is not particularly limited and may be properly selected according to contemplated purposes. The thickness of the film is preferably 2 μm to 150 more preferably 5 μM to 100 μM, particularly preferably 8 μm to 50 μm.

The shape of the support is not particularly limited and may be properly selected according to contemplated purposes. The support, however, is preferably elongated. The length of the elongated support is not particularly limited. For example, the length of the elongated support is 10 m to 20,000 m.

### —Curing Layer—

The curing layer is not particularly limited and may be properly selected according to contemplated purposes, as long as the curing layer is formed of the curable composition.

The number of curing layers stacked is not particularly limited and may be properly selected according to contemplated purposes. For example, the curing layer may have a single-layer structure or alternatively may have a multilayer structure of two or more layers.

The curing layer may be formed by a method that includes dissolving, emulsifying, or dispersing the curable composition according to the present invention in water or a solvent to prepare a curable composition solution, coating the curable composition solution onto the support directly, and drying the coating to stack the layer.

The solvent for the curable composition solution is not particularly limited and may be properly selected according to contemplated purposes. Examples thereof include alcohols such as methanol, ethanol, n-propanol, iso-propanol, n-butanol, sec-butanol, and n-hexanol; ketones such as acetone, methyl ethyl ketone, methyl isobutyl ketone, cyclohexanone, and diisobutyl ketone; esters such as ethyl acetate, butyl acetate, n-amyl acetate, methyl sulfate, ethyl propionate, dimethyl phthalate, ethyl benzoate, and methoxypropyl acetate; aromatic hydrocarbons such as toluene, xylene, benzene, and ethylbenzene; halogenated hydrocarbons such as carbon tetrachloride, trichloroethylene, chloroform, 1,1,1-trichloroethane, methylene chloride, and monochlorobenzene; ethers such as tetrahydrofuran, diethyl ether, ethylene glycol monomethyl ether, ethylene glycol monoethyl ether, and 1-methoxy-2-propanol; and dimethylformamide, dimethylacetamide, dimethylsulfo oxide, and sulfolane. One type of them may be used, or alternatively, two or more types of them may be used in combination. Further, conventional surfactants may be added.

Any method may be used for coating without particular limitation, and the method may be properly selected according to contemplated purposes. Examples thereof include a method including directly coating the composition solution onto the support, for example, using a spin coater, a slit spin coater, a roll coater, a die coater, or a curtain coater.

Conditions for drying may vary depending upon ingredients, the type of solvents, mixing ratios and the like. In general, however, the drying is carried out at a temperature of 60° C. to 110° C. for about 30 sec to about 15 min.

The thickness of the curing layer is not particularly limited and may be properly selected according to contemplated purposes. For example, however, the thickness of the curing layer is preferably 1 μm to 100 μm, more preferably 2 μm to 50 μm, particularly preferably 4 μm to 30 μm.

### <<Other Layers>>

Other layers may be provided without particular limitation and may be properly selected according to contemplated purposes. Examples thereof include protective films, thermoplastic resin layers, barrier layers, peel layers, adhesion layers, light absorbing layers, and surface protective layers. The curable film may have one type of these layers or two or more types of these layers.

### <<Protective Film>>

In the curable film, a protective film may be formed on the curing layer.

Examples of such protective films include films as used in the support, papers, and papers laminated with polyethylene or polypropylene. Among them, polyethylene and polypropylene films are preferred.

The thickness of the protective film is not particularly limited and may be properly selected according to contemplated purposes. For example, the thickness of the protective film is preferably 5 μm to 100 μm, more preferably 8 μm to 50 μm, particularly preferably 10 μm to 30 μm.

Examples of the combination of the support and the protective film (support/protective film) include polyethylene terephthalate/polypropylene, polyethylene terephthalate/polyethylene, polyvinyl chloride/cellophane, polyimide/polypropylene, and polyethylene terephthalate/polyethylene terephthalate. The interlayer adhesion can be regulated by surface-treating at least one of the support and the protective film. The surface of the support may be treated to enhance the adhesion of the support to the curing layer. Examples of surface treatment methods include the provision of undercoating layer, corona discharge treatment, flame treatment, ultraviolet irradiation treatment, high frequency irradiation treatment, glow discharge irradiation treatment, active plasma irradiation treatment, and laser beam irradiation treatment.

The coefficient of static friction between the support and the protective film is preferably 0.3 to 1.4, more preferably 0.5 to 1.2.

When the coefficient of static friction is 0.3 or more, it is possible to prevent uneven winding in a roll form due to too slippery properties. When the coefficient of static friction is 1.4 or less, winding to a good roll state is possible.

Preferably, the curable film is wound around a cylindrical winding core and is stored in a continuous roll form. The length of the continuous curable film is not particularly limited and may be properly selected, for example, from a range of 10 m to 20,000 m. Further, a method may be adopted in which the curable film is slit so that the user can easily handle the curable film, and the continuous slit curable film of 100 m to 1,000 m in length is wound as a roll. In this case, preferably, the curable film is wound so that the support is located on the outermost side. The roll of the curable film may be slit to sheets. In storing the curable film, from the viewpoints of protecting the end face and preventing edge fusion, a separator (particularly a moisture-proof or desiccant-containing separator) is provided at the end face. Further, the use of a material having low permeability to moisture is preferred for packing.

The surface of the protective film may be treated to regulate the adhesion between the protective film and the curing layer. The surface treatment may be carried out by forming an undercoating layer formed of polymers such as polyorganosiloxane, fluorinated polyolefin, polyfluoroethylene, or polyvinyl alcohol on the surface of the protective film. The undercoating layer may be formed by coating a coating liquid of the polymer on the surface of the protective film and then drying the coating at 30° C. to 150° C. for 1 min to 30 min. The drying temperature is particularly preferably 50° C. to 120° C.

### (Curable Laminate)

The curable laminate includes at least a substrate and a curing layer provided on the substrate. Other layers that are properly selected according to purposes are stacked thereon.

The curing layer is one transferred from the curable film prepared by the above process and has the same construction as described above.

### <Substrate>

The substrate serves as a substrate on which a curing layer is to be formed, or a transfer object on which at least a curing layer in the curable film according to the present invention is transferred. The substrate is not particularly limited and may be properly selected according to contemplated purposes. For example, any substrate may be selected from substrates having a high surface smoothness to substrates having a concave and convex surface. The substrate is preferably in a plate form, that is, a board is used. Specifically, examples of substrates include conventional boards for printed wiring board production (printed boards), glass plates (for example, soda glass plates), synthetic resin films, papers, and metal plates.

### <Process for Producing Curable Laminate>

The curable laminate may be produced by transferring and stacking at least a curing layer in the curable film according to the present invention while performing at least one of heating and pressing.

The curable laminate is produced by stacking the curable film according to the present invention on the surface of the substrate while performing at least one of heating and pressing. When the curable film includes the protective film, the protective film is peeled off and the curing layer is then stacked on the substrate so that the curing layer is superimposed on the substrate.

The heating temperature is not particularly limited and may be properly selected according to contemplated purposes. For example, the heating temperature is preferably 15° C. to 180° C., more preferably 60° C. to 140° C.

The pressure applied for pressing is not particularly limited and may be properly selected according to contemplated purposes. For example, the pressure is preferably 0.1 MPa to 1.0 MPa, more preferably 0.2 MPa to 0.8 MPa.

At least one of the heating and pressing may be carried out by any apparatus without particular limitation. The apparatus may be properly selected according to contemplated purposes. Examples of suitable apparatuses include laminators (for example, VP-II manufactured by TAISEI LAMINATOR CO, LTD. and VP130 manufactured by Nichigo-Morton Co., Ltd.).

The curable film and the curable laminate according to the present invention have an even film thickness and hardly have surface defects such as pinholes or cissing and thus can efficiently form permanent patterns (for example, protective films, interlayer insulating films, and solder resist patterns) having excellent insulating reliability and high definition. Accordingly, the curable film and the curable laminate according to the present invention can be extensively used for the formation of highly definite permanent patterns in the field of electronic materials and are particularly suitable for the formation of permanent patterns in printed boards.

### (Method for Forming a Permanent Pattern)

The method for forming a permanent pattern according to the present invention includes at least an exposure step and further properly selected optional other steps such as a development step.

### <Exposure Step>

In the exposure step, the curing layer in the curable laminate according to the present invention is exposed to light. The curable laminate according to the present invention is as described above.

Any object may be exposed to light without particular limitation and may be properly selected according to contemplated purposes, as long as the object is a curing layer in the curable laminate. For example, preferably, a laminate formed by stacking a curable film on a base material while performing at least one of heating and pressing is exposed to light.

The exposure is not particularly limited and may be properly selected according to contemplated purposes. Examples thereof include digital exposure and analog exposure. Among them, digital exposure is preferred.

### <Other Steps>

Other steps may be provided without particular limitation and may be properly selected according to contemplated purposes. Examples of such other steps include a base material surface treatment step, a development step, a curing treatment step, and a post exposure step.

### <<Development Step>>

The development is carried out by removing unexposed areas of the curing layer.

The unexposed areas may be removed by any method without particular limitation, and the method may be properly selected according to contemplated purposes. Examples of such method include a method that removes the unexposed areas with a developing solution.

The developing solution is not particularly limited and may be properly selected according to contemplated purposes. Examples thereof include aqueous alkaline solutions, aqueous developing solutions, and organic solvents. Among them, weakly alkaline aqueous solutions are preferred. Examples of base ingredients in weakly alkaline aqueous solutions include lithium hydroxide, sodium hydroxide, potassium hydroxide, lithium carbonate, sodium carbonate, potassium carbonate, lithium hydrogencarbonate, sodium hydrogencarbonate, potassium hydrogencarbonate, sodium phosphate, potassium phosphate, sodium pyrophosphate, potassium pyrophosphate, and borax.

Preferably, the weakly alkaline aqueous solution has a pH value of, for example, 8 to 12, more preferably 9 to 11. Examples of weakly alkaline aqueous solutions include 0.1% by mass to 5% by mass aqueous sodium carbonate or potassium carbonate solutions.

The temperature of the developing solution may be properly selected according to the develop ability of the curing layer and is, for example, preferably about 25° C. to about 40° C.

The developing solution may be used in combination with surfactants, antifoaming agents, organic bases (for example, ethylenediamine, ethanolamine, tetramethylammonium hydroxide, diethylenetriamine, triethylenepentamine, morpholine, and triethanolamine) and organic solvents for development acceleration (for example, alcohols, ketones, esters, ethers, amides, and lactones). The development solution may be an aqueous developing solution obtained by mixing water or an aqueous alkali solution with an organic solvent, or alternatively, an organic solvent may be used solely as the developing solution.

### <<Curing Treatment Step>>

In the curing treatment step, after the development step, the patterned curing layer is cured.

The curing treatment step is not particularly limited and may be properly selected according to contemplated purposes. Suitable examples of the curing treatment step include whole area exposure treatment and whole area heating treatment.

Examples of whole area exposure methods include a method in which, after the development, the whole area on the laminate with the permanent pattern formed thereon is exposed. In the whole area exposure, the curing of the resin in the curable composition constituting the curing layer is accelerated to cure the surface of the permanent pattern.

The whole area exposure may be carried out by any apparatus without particular limitation, and the apparatus may be properly selected according to contemplated purposes. Examples thereof include UV (ultraviolet) exposure apparatuses such as ultrahigh-pressure mercury lamps.

Examples of whole area heating treatment methods include a method in which, after the development, the whole area on the laminate with the permanent pattern formed thereon is heated. The whole area heating can enhance the film strength of the surface of the permanent pattern.

The heating temperature in the whole area heating is preferably 120° C. to 250° C., more preferably 120° C. to 200° C. When the heating temperature is 120° C. or above, the heating treatment can improve the film strength. When the heating temperature is 250° C. or below, weakening and embrittlement of the film as a result of the decomposition of the resin in the curable composition can be prevented.

The heating time in the whole area heating is preferably 10 min to 120 min, more preferably 15 min to 60 min.

The whole area heating may be carried out by any apparatus without particular limitation, and the apparatus may be properly selected from conventional apparatuses according to contemplated purposes. Examples thereof include dry ovens, hot plates, and IR (infrared) heaters.

When the permanent pattern is formed by a method for forming a permanent pattern that forms at least any of a protective film, an interlayer insulating film, and a solder resist pattern, a method may be adopted in which a permanent pattern is formed by the method for forming a permanent pattern on a printed wiring board followed by soldering by the following method.

Specifically, a curing layer as the permanent pattern is formed by the development, and a metal layer is exposed on the surface of the printed wiring board, the metal layer site exposed on the surface of the printed wiring board is plated with gold and is then soldered. A semiconductor or a component is mounted at the soldered site. At that time, the permanent pattern formed of the cured layer functions as a protective film, an insulating film (an interlayer insulating film), or a solder resist and can protect the assembly against external impact or conduction between adjacent electrodes.

### (Printed Board)

The printed board according to the present invention includes at least a substrate, a permanent pattern formed by the method for forming a permanent pattern and further properly selected optional other elements.

The other elements are not particularly limited and may be properly selected according to contemplated purposes. Examples thereof include an insulating layer additionally provided between the base material and the permanent pattern to constitute a build-up board.

### EXAMPLES

The present invention will be described with reference to the following Examples. However, it should be noted that the present invention is not limited to these Examples.

### Example 1

### —Preparation of Resin-Coated Inorganic Fine Particles J-1—

25 g of an epoxy resin (YDF2004 manufactured by Tohto Kasei Co., Ltd.) and 1 L of MMPGAc (manufactured by Daicel Chemical Industries, Ltd.) were added into a 2,000-mL three-necked flask equipped with a reflux tube and a thermometer, followed by dissolution. 150 g of silica (particle diameter 0.5 μm) that had been surface-treated with N-(β-aminoethyl)-γ-aminopropylsilane (KBM-603, manufactured by Shin-Etsu Chemical Co., Ltd.), a silane coupling agent, was added under stirring, and the mixture was treated at 100° C. under vigorous stirring at 400 rpm. After the elapse of 2 hr from the completion of the addition, heating was stopped, and the flask was allowed to stand to room temperature. 600 mL of MEK (methyl ethyl ketone) was then added, and the mixture was stirred for 1 hr. After standing, the solvent was removed by decantation. The residue was washed twice with MEK, was then collected by filtration, and was dried at 80° C. in a vacuum oven for 6 hr to give 145 g of a resin coated silica J-1.

### —Composition of Curable Composition Solution—

| | | |
|---|---|---|
| Binder: Bisphneol epoxy acrylate (ZFR-1776H | 64 | parts by mass |
| manufactured by Nippon Kayaku Co., Ltd.: 45% | | |
| by mass MMPGAc solution) | | |
| Polymerizable compound: dipentaerythritol | 5 | parts by mass |
| hexaacrylate (A-DPH manufactured by Shin- | | |
| Nakamura Chemical Co., Ltd.) | | |
| Initiator: 1,3-α-Aminoalkylphenone (IRG907 | 1.9 | parts by mass |
| manufactured by Ciba Specialty Chemicals, K.K.) | | |
| 2,4-Diethylthioxanthone (DETX manufactured by | 0.02 | part by mass |
| Nippon Kayaku Co., Ltd.) | | |
| Diethylaminobenzophenone (EAB-F | 0.06 | part by mass |
| manufactured by Hodogaya Chemical Co., Ltd.) | | |
| Thermal curing accelerator: Dicyan diamide | 2.6 | parts by mass |
| (DICY-7 manufactured by Yuka Shell Epoxy | | |
| K.K.) | | |
| Thermal crosslinking agent: Bisphenol A epoxy | 7.5 | parts by mass |
| resin (Epototo YDF- 170 manufactured by Tohto | | |
| Kasei Co., Ltd.) | | |
| Pigment dispersion: | 50 | parts by mass |
| Others: Fluorosurfactant (Megafac F-780F | 0.13 | parts by mass |
| manufactured by Dainippon Ink and Chemicals, | | |
| Inc.: 30% by mass methyl ethyl ketone solution) | | |
| Methyl ethyl ketone (solvent): | 12.0 | parts by mass |

The pigment dispersion was prepared by premixing 30 parts by mass of the resin-coated fine particles, 48.2 parts by mass of a solution of the binder, 0.34 part by mass of phthalocyanine blue, 0.11 part by mass of the anthraquinone yellow pigment (PY24), and 59.0 parts by mass of n-propyl acetate and dispersing them with zirconia beads having a diameter of 1.0 mm at a peripheral speed of 9 m/sec for 3 hr with Motor Mill M-250 (manufactured by Eiger).

### —Production of Curable Film—

The curable composition solution having the above composition was coated onto a 16 μm-thick polyethylene terephthalate film (16FB50 manufactured by Toray Co., Ltd.) as a support, and the coating was dried to form a 30 μm-thick curing layer on the support. A 20 μm-thick polypropylene film (ALPHAN E-200 manufactured by Oji Specialty Paper Co. Ltd.) was stacked as a protective layer on the curing layer to produce a curable film.

### —Stacking on Substrate—

The surface of a copper clad laminate (throughhole-free laminate, copper thickness 12 μm) was chemically polished to prepare a substrate. The curable film was stacked on the copper clad laminate with a vacuum laminator (VP130 manufactured by Nichigo-Morton Co., Ltd.) while peeling off the protective film from the curable film so that the curing layer in the curable film was brought into contact with the copper clad laminate. Thus, a curable laminate including the copper clad laminate, the curing layer, and the polyethylene terephthalate film (support) stacked in that order was prepared.

Contact bonding was carried out under conditions of a vacuuming time of 40 sec, a contact bonding temperature of 70° C., a contact bonding pressure of 0.2 MPa, and a pressing time of 10 sec.

### Example 2

A curable film and a curable laminate of Example 2 were produced in the same manner as in Example 1, except that, in the preparation of the resin-coated inorganic fine particles, a polyester resin (Placcel 312 manufactured by Daicel Chemical Industries, Ltd.) was used instead of the epoxy resin.

### Example 3

A curable film and a curable laminate of Example 3 were produced in the same manner as in Example 1, except that, in the preparation of the resin-coated inorganic fine particles, 3-methacryloxypropyltrimethoxysilane (KBM-503 manufactured by Shin-Etsu Chemical Co., Ltd.) was used instead of N-(β-aminoethyl)-γ-aminopropylsilane (KBM-603 manufactured by Shin-Etsu Chemical Co., Ltd.) and PMMA obtained by polymerizing MMA (methyl methyacrylate: manufactured by Mitsubishi Rayon Co., Ltd.) in situ was used as the binder resin.

### Example 4

A curable film and a curable laminate of Example 4 were produced in the same manner as in Example 1, except that, in the preparation of the resin-coated inorganic fine particles in Example 1, 3-mercaptopropyltrimethoxysilane (KBM-803 manufactured by Shin-Etsu Chemical Co., Ltd.) was used instead of N-(β-aminoethyl)-γ-aminopropylsilane (KBM-603 manufactured by Shin-Etsu Chemical Co., Ltd.) and a polybutadiene resin (Polybd R45HT manufactured by Idemitsu Kosan Co., Ltd.) was used instead of the epoxy resin.

### Example 5

A curable film and a curable laminate of Example 5 were produced in the same manner as in Example 1, except that a polyester resin synthesized by the following method was used instead of the bisphenol F epoxy acrylate resin.

### —Synthesis of Polyester Resin—

183 parts by mass of a bisphenol F epoxy resin (YDF-2001 manufactured by Tohto Kasei Co., Ltd.), 64 parts by mass of cyclohexanone, 35 parts by mass of tetrahydrophthalic acid (manufactured by Tokyo Chemical Industry Co., Ltd.), and 3.6 parts by mass of tetrabutylammonium bromide (manufactured by Tokyo Chemical Industry Co., Ltd.) were added into a 2,000-mL flask equipped with an stirrer, a reflux tube, a thermometer, and a nitrogen gas introduction tube, and the mixture was stirred at 140° C. for 4 hr. After the completion of the reaction, 108 parts by mass of tetrahydrophthalic acid anhydride (manufactured by Tokyo Chemical Industry Co., Ltd.) was added, and the mixture was stirred at 120° C. for 6 hr to obtain a polyester resin. Thereafter, the polyester resin was diluted with 127 parts by mass of methyl ethyl ketone. The polyester resin thus obtained had a weight average molecular weight of 29,000 and an acid value of 133 mgKOH/g.

### Example 6

A curable film and a curable laminate of Example 6 were produced in the same manner as in Example 1, except that a biphenyl epoxy acrylate resin (ZCR1461H manufactured by Nippon Kayaku Co., Ltd.) was used instead of the bisphenol F epoxy acrylate resin.

### Example 7

A curable film and a curable laminate of Example 7 were produced in the same manner as in Example 1, except that resin-coated inorganic fine particles J-X prepared by the following method was used instead of the resin-coated inorganic fine particles J-1.

### —Preparation of Resin-Coated Inorganic Fine Particles J-X—

16.3 g of methylenebis(4,1-phenylene) diisocyanate (MDI manufactured by Nippon Polyurethane Industry Co., Ltd.), 3.9 g of dimethylolpropionic acid (DMPA manufactured by Tokyo Chemical Industry Co., Ltd.), 4.3 g of glycerol monomethacrylate (GLM manufactured by Nippon Oils & Fats Co., Ltd.), and 25 g of MMPGAc (manufactured by Daicel Chemical Industries, Ltd.) were added into a 2,000-mL three-necked flask equipped with a reflux tube and a thermometer, and the mixture was allowed to react at 80° C. for 4 hr. Under stirring at 400 rpm, 500 mL of MMPGAc was added. Thereafter, 150 g of silica (particle diameter 0.5 μm) that had been surface-treated with N-(β-aminoethyl)-γ-aminopropylsilane was added, followed by treatment at 80° C. Two hours after the initiation of the treatment, the heating was stopped, and the solution was allowed to stand to room temperature. Thereafter, 1,000 mL of MEK (methyl ethyl ketone) was added, and the mixture was stirred for 1 hr. After standing, the solvent was removed by decantation, and the residue was washed twice with MEK, was collected by filtration, and was dried at 80° C. in a vacuum oven for 6 hr to obtain 142 g of a resin-coated silica J-X.

### Example 8

A curable film and a curable laminate of Example 8 were produced in the same manner as in Example 7, except that a polyurethane resin Ul prepared by the following method was used instead of the bisphenol F epoxy acrylate resin.

### Synthesis of Acid-Modified Vinyl-Containing Polyurethene Resin U1—

10.86 g (0.081 mol) of 2,2-bis(hydroxymethyl)propionic acid (DMPA) and 16.82 g (0.105 mol) of glycerol methacrylate (GLM) were dissolved in 79 mL of propylene glycol monomethyl ether monoacetate in a 500-mL three-necked round flask equipped with a condenser and a stirrer. With 37.54 g (0.15 mol) of 4,4-diphenylmethane diisocyanate (MDI), 0.1 g of 2,6-di-t-butylhydroxytoluene as a catalyst, 0.2 g of NEOSTAN U-600 (tradename; manufactured by Nitto Kasei Co. Ltd.) was added, and the mixture was stirred at 75° C. for 5 hr. Thereafter, the solution was diluted with 9.61 mL of methyl alcohol, and the mixture was stirred for 30 min to obtain 145 g of a polymer solution. The acid-modified vinyl-containing polyurethane resin thus synthesized is U1 in the table below.

The acid-modified vinyl-containing polyurethane resin U1 thus obtained had an acid value of 70 mgKOH/g in terms of solid matter, a mass average molecular weight (using a polystyrene standard) of 8,000 as measured by gel permeation chromatography (GPC), and a vinyl group equivalent of 1.5 mmol/g.

The acid value was measured according to JIS K 0070. When the sample did not melt, for example, dioxane or tetrahydrofuran was used as a solvent.

The mass average molecular weight was measured with a high-speed gel permeation chromatography (GPC) (HLC-802A, manufactured by TOSOH Co., Ltd.). Specifically, a 0.5% by mass THF solution was used as a sample solution. 62 columns of TSKgel GMH were provided. The sample (200 μL) was injected and eluted with the THF solution, followed by measurement at 25° C. with a refractive index detector. The mass average molecular weight was determined with a molecular weight distribution curve that had been calibrated using standard polystyrene.

The vinyl group equivalent was determined by measuring a bromine value according to JIS K 2605.

### Example 9

A curable film and a curable laminate of Example 9 were produced in the same manner as in Example 1, except that a polyester resin synthesized by the following method was used instead of the epoxy resin, cyclohexanone was used instead of MMPGAc, and a polyester resin syntheized by the following emthod was used instead of the bisphenol F epoxy acrylate resin.

### Synthesis of Polyester Resin—

70 parts by mass of dimethyl terephthalte, 52 parts by mass of dimethyl isophthalate, 23 parts by mass of dimethyl adipate, 55 parts by mass of dimethyl sebacate, 42 parts by mass of 2,2-dimethylpropanediol, 32 parts by mass of butanediol, 77 parts by mass of ethylene glycol, 0.2 part by mass of an antioxidant (Irganox 1330; manufactured by Ciba Japan K.K. and 0.1 part by mass of tetrabutyl titanate were placed in a reactor. The mixture was heated to room temperature to 260° C. with stirring over a period of 2 hr and was then heated at 260° C. for 1 hr to perform transesterification. Subsequently, the interior of the reactor was gradually evacuated and, at the same time, was heated and brought to 245° C. and 0.5 torr to 2 torr over a period of 30 min to allow an initial polycondensation reaction to proceed. Further, a polymerization was allowed to proceed at 245° C. and 0.5 torr to 2 torr for 4 hr. The pressure within the reactor was returned to atmospheric pressure while introducting dry nitrogen over a period of 30 min, and polyester pellets were taken out of the reactor to obtain a polyester. The polyester thus obtained was dissolved in and diluted with cyclohexanone to give a solid content of 30% by mass to prepare a polyester solution. The polyester had a molecular weight of 45,000.

### Comparative Example 1

A curable film and a curable laminate of Comparative Example 1 were produced in the same manner as in Example 1, except that silica (SO—C2 manufactured by Admatec; average molecular diameter 0.5 μm) was used instead of the resin-coated inorganic fine particles.

### Comparative Example 2

A curable film and a curable laminate of Comparative Example 2 were produced in the same manner as in Example 1, except that PMMA resin fine particles (EPOSTAR MA1001 manufactured by Nippon Shokubai Kagaku Kogyo Co., Ltd.; average molecular diameter 1.0 μm) were used instead of the resin-coated inorganic fine particles.

### (Measuring Method and Evaluation Method)

### <Smoothness>

A solder resist layer was formed by an ordinary method on a printed board including a 12 μm-thick copper foil stacked on a glass epoxy base material, and the assembly was exposed to light at an optimal exposure (300 mJ/cm² to 1 J/cm²).

The assembly was then allowed to stand at room temperature for 1 hr and was then subjected to spray development with a 1% by mass aqueous sodium carbonate solution of 30° C. for 60 sec and was further heated (dried) at 80° C. for 10 min. Subsequently, the curing layer was exposed to ultraviolet light at an energy amount of 1 J/cm² with an ultraviolet irradiation apparatus manufactured by Orc manufacturing Corporation. Further, the exposed curing layer was heated at 150° C. for 60 min to form a solder resist. Thus, a board for evaluation was obtained.

For the solder resist thus obtained, the surface roughness of the film was observed with Surfcom S70A manufactured by Tokyo Seimitsu Co., Ltd. The results are shown in Table 2 below.

### [Evaluation Standard]

A: The ten-point average roughness is 0.3 μm or less, and the surface roughness is good.

B: The ten-point average roughness is 0.3 μm (exclusive) to 0.5 μm (inclusive), and the surface roughness is somewhat poor.

C: The surface roughness is poor.

### <Toughness>

A solder resist layer was formed using the curable laminate by an ordinary method on a printed board including a 12 μm-thick copper foil stacked on a glass epoxy base material, and the assembly was exposed to light through a 2 mm-square photomask with an HMW-201GX exposure apparatus manufactured by Orc manufacturing Corporation at an optimal exposure (300 mJ/cm² to 1 J/cm²) that could form a 2 mm-square pattern. The assembly was then allowed to stand at room temperature for 1 hr and was then subjected to spray development with a 1% by mass aqueous sodium carbonate solution of 30° C. for 60 sec and was further heated (dried) at 80° C. for 10 min. Subsequently, the curing layer was exposed to ultraviolet light at an energy amount of 1 J/cm² with an ultraviolet irradiation apparatus manufactured by Orc manufacturing Corporation. Further, the exposed curing layer was heated at 150° C. for 60 min to form a solder resist having 2 mm-square openings. Thus, a board for evaluation was obtained.

The board thus obtained was exposed to the air at −65° C. for 15 min, was then exposed to the air at 150° C. for 15 min, and was then again exposed to the air at −65° C. The above heat cycle was repeated 1,000 times. For the evaluation board subjected to the heat cycle, the level of cracking or separation on the solder resist was observed under an optical, microscope. The results are shown in Table 2 below.

### [Evaluation Standard]

A: The solder resist is free from cracking and separation and has excellent toughness.

B: The solder resist is slightly cracked but still has good toughness.

C: The solder resist is slightly cracked and separated and has somewhat poor toughness.

D: The solder resist is clearly cracked and separated and has poor toughness.

### <Heat Resistance>

A solder resist layer of each curable composition was formed on a board, and a rosin flux was coated to prepare a board for evaluation. The board was immersed in a solder bath present at 260° C. for 30 sec, and the flux was washed with a denaturated alcohol. Thereafter, the resist layer was visually inspected for bulging, separation, and a change in color, followed by evaluation according to the following standard. The results are shown in Table 2 below.

### [Evaluation Standard]

A: The coating film remains unchanged and has excellent heat resistance.

B: The coating film is slightly bulged and separated but still has good heat resistance.

C: The coating film is partly bulged and separated and has poor heat resistance.

D: The coating film is bulged and separated.

### <Evaluation of Resolution>

The curable laminate was allowed to stand at room temperature (23° C.) and 55% RH for 10 min. The curable laminate was exposed to light from the top of the polyethylene terephthalate film (support) with the above apparatus for pattern formation using a circular hole pattern so that circular holes having a diameter of 50 μm to 200 μm in width were formed.

In this case, the exposure was a photo energy amount necessary for curing the curing layer in the curable film in the evaluation of the sensitivity. The exposed laminate was allowed to stand at room temperature for 10 min, and the polyethylene terephthalate film (support) was peeled off from the cured laminate.

The whole area of the curing layer on the copper-clad laminate was sprayed with a 1% by mass aqueous sodium carbonate solution as the developing solution of 30° C. at a spray pressure of 0.15 MPa for a period of twice longer than the shortest development time to dissolve and remove areas remaining uncured.

The surface of the copper-clad laminate with the cured resin pattern formed thereon was observed under an optical microscope to measure a minimum circular hole pattern width that is free from a residue in the bottom of circular holes in the pattern, is free from turning-up or separation of the pattern part, and can realize space formation. The minimum circular hole pattern width was regarded as a resolution and was evaluated according to the following standards. The smaller the numerical value, the better the resolution. The results are shown in Table 2 below.

### [Evaluation Standard]

A: Circular holes having a diameter of 90 μm or less can be resolved, and the resolution is excellent.

B: Circular holes having a diameter of 90 μm (exclusive) to 120 μm (inclusive) can be resolved, and the resolution is good.

C: Circular holes having a diameter of 120 μm (exclusive) to 200 μm (inclusive) can be resolved, and the resolution is somewhat poor.

D: Circular holes cannot be resolved, and the resolution is poor.

### <Insulating Properties>

A copper foil in a printed board including a 12 μm-thick copper foil stacked on a glass epoxy base material was etched to obtain a comb-shaped electrode including lines that had a line width/space width of 50 μm/50 μm, are not in contact with each other, and face each other on an identical plane. The curable laminate was formed on the comb-shaped electrode in the board, and a solder resist layer was formed by an ordinary method, followed by exposure at an optimal exposure (300 mJ/cm² to 1 J/cm²). The assembly was then allowed to stand at room temperature for 1 hr and was then subjected to spray development with a 1% by mass aqueous sodium carbonate solution of 30° C. for 60 sec and was further heated (dried) at 80° C. for 10 min. Subsequently, the curing layer was exposed to ultraviolet light at an energy amount of 1 J/cm² with an ultraviolet irradiation apparatus manufactured by Orc manufacturing Corporation. Further, the exposed curing layer was heated at 150° C. for 60 min to form a solder resist. Thus, a board for evaluation was obtained.

Polytetrafluoroethylene shield wires were connected to the comb-shaped electrode by Sn/Pb solder so that a voltage could be applied across the comb-shaped electrodes in the heated laminate for evaluation. Thereafter, in such a state that a voltage of 5 V was applied to the laminate for evaluation, the laminate for evaluation was allowed to stand in a super accelerating high temperature/high humidity service life test (HAST) bath of 130° C. and 85% RH for 200 hr. The level of migration of the solder resist in the laminate for evaluation was observed under a metallographic microscope (magnification 100 times). The results are shown in Table 2 below.

### [Evaluation Standard]

A: The occurrence of migration is not noticeable, and the insulating properties are excellent.

B: The occurrence of migration on copper is slightly noticeable, but the insulating properties are good.

C: The occurrence of migration is noticeable, and the insulating properties are somewhat poor.

D: Shortcircuiting between electrodes occurs, and the insulating properties are poor.

### (Method for Structural Analysis of Resin-Coated Inorganic Fine Particles)

The coated silica fine particles were observed under a scanning electron microscope. As a result, it was confirmed that coalescence among particles did not occur and the resin covered the fine particles.

### (Method for Measuring SP Value)

The SP value (MPa^{1/2}) was calculated using parameters (Okitsu method) from polymer structures described in reference 1. The results are shown in Table 1 below.

Reference 1: Journal of the Adhesion Society of Japan, Vol. 29, No. 5 (1993)

TABLE 1

| | | | | | | SP value |
|---|---|---|---|---|---|---|
| | | | SP value | | SP Value | difference |
| | Silane coupling agent | (A) | (A) | (B) | (B) | (A) − (B) |
| | Functional group | Coating resin | [MPa^{1/2}] | Binder | [MPa^{1/2}] | [MPa^{1/2}] |
| Example 1 | Amino group | Epoxy resin | 23 | Bisphenol F epoxy | 22 | 1 |
| | | | | acrylate | | |
| Example 2 | Amino group | Polyester resin | 21 | Bisphenol F epoxy | 22 | 1 |
| | | | | acrylate | | |
| Example 3 | Methacryloyl group | PMMA | 20 | Bisphenol F epoxy | 22 | 2 |
| | | | | acrylate | | |
| Example 4 | SH group | Polybutadiene | 19 | Bisphenol F epoxy | 22 | 3 |
| | | | | acrylate | | |
| Example 5 | Amino group | Epoxy resin | 23 | Polyester | 22 | 1 |
| Example 6 | Amino group | Epoxy resin | 23 | Biphenyl epoxy acrylate | 22 | 1 |
| Example 7 | Amino group | Polyurethane | 25 | Bisphenol F epoxy | 22 | 3 |
| | | resin | | acrylate | | |
| Example 8 | Amino group | Polyurethane | 27 | Polyurethane U1 | 25 | 2 |
| | | resin | | | | |
| Example 9 | Amino group | Polyester resin | 22 | Polyester | 23 | 1 |
| Comparative | — | — | — | Bisphenol F epoxy | 22 | — |
| Example 1 | | | | acrylate | | |
| Comparative | — | PMMA | 20 | Bisphenol F epoxy | 22 | 2 |
| Example 2 | | | | acrylate | | |

TABLE 2

| | Smooth- | Heat | | | Insulating |
|---|---|---|---|---|---|
| | ness | resistance | Toughness | Resolution | properties |
| Example 1 | A | A | A | A | A |
| Example 2 | A | A | A | A | A |
| Example 3 | A | B | B | A | A |
| Example 4 | A | B | A | B | B |
| Example 5 | A | A | B | A | B |
| Example 6 | A | A | B | A | A |
| Example 7 | A | A | A | A | A |
| Example 8 | A | A | A | A | A |
| Example 9 | A | B | B | A | A |
| Comparative | C | C | C | C | C |
| Example 1 | | | | | |
| Comparative | B | C | C | A | D |
| Example 2 | | | | | |

### INDUSTRIAL APPLICABILITY

The curable composition according to the present invention can realize enhanced sensitivity and can improve board adhesion, surface hardness, heat resistance, and storage stability and thus is suitable for use in film-type solder resists.

The curable film according to the present invention has improved heat resistance and storage stability and can efficiently form a high definition permanent pattern and thus is suitable for use in the formation of various patterns, for example, permanent patterns such as protective films, interlayer insulating films, and solder resist patterns, the production of liquid crystal structural members such as color filters, columnar materials, rib materials, spacers, and partition walls, holograms, micromachines, and proofs and is particularly suitable for use in the formation of permanent patterns in printed boards.

The method for pattern formation according to the present invention uses the curable composition and thus is suitable for use in the formation of various patterns, for example, permanent patterns such as protective films, interlayer insulating films, and solder resist patterns, the production of liquid crystal structural members such as color filters, columnar materials, rib materials, spacers, and partition walls, holograms, micromachines, and proofs and is particularly suitable for use in the formation of permanent patterns in printed boards.

1-13. (canceled)

14. A curable composition comprising:
resin-coated inorganic fine particles.

15. The curable composition according to claim 14, further comprising a thermal crosslinking agent and a thermal curing accelerator.

16. The curable composition according to claim 14, further comprising a photopolymerization initiator and a polymerizable compound.

17. The curable composition according to claim 14, further comprising a binder.

18. The curable composition according to claim 14, wherein inorganic fine particles of the resin-coated inorganic fine particles are silica particles.

19. The curable composition according to claim 14, wherein the resin-coated inorganic fine particles are formed by coating, with a thermoplastic resin, inorganic fine particles containing an organic linking chain formed of a mercapto group, a hydroxyl group, an amino group, an isocyanato group, or a glycidyl group.

20. The curable composition according to claim 19, wherein the thermoplastic resin is a resin obtained by polycondensation or addition polymerization.

21. The curable composition according to claim 19, wherein a difference in SP value between the thermoplastic resin and the binder is 5 MPa^{1/2} or less.

22. The curable composition according to claim 14, wherein the curable composition is used as a curable composition for a printed board.

23. A curable film comprising:
a support; and
a curing layer including a curable composition containing resin-coated inorganic fine particles, the curing layer being provided on the support.

24. A curable laminate comprising:
a substrate; and
a curing layer including a curable composition containing resin-coated inorganic fine particles, the curing layer being provided on the substrate.
